(19) United States
(12) Patent Application Publication
(10) Pub. No.: US 2015/0025132 A1
(43) Pub. Date: Jan. 22, 2015

(54) COMPOSITIONS AND METHODS FOR INHIBITING ENDOSPORES USING GREEN TEA POLYPHENOLS

(71) Applicants: Georgia Regents University, Augusta, GA (US); Montclair State University, Montclair, NJ (US); Seton Hall University, South Orange, NJ (US)

(72) Inventors: Stephen Hsu, Evans, GA (US); Lee H. Lee, Edison, NJ (US); Tin-Chun Chu, South Orange, NJ (US)

(21) Appl. No.: 14/333,279

(22) Filed: Jul. 16, 2014

Related U.S. Application Data
(60) Provisional application No. 61/846,784, filed on Jul. 16, 2013.

(51) Int. Cl. A01N 43/16; A23L 3/3544

(52) U.S. Cl. CPC A01N 43/16; A23L 3/3544; A23V 2002/00
USPC 514/456; 435/252.1; 435/257.1; 435/242

(57) ABSTRACT

Compositions and methods of killing, inactivating, or otherwise reducing the spores such as bacterial spores are disclosed. The methods typically include reducing or preventing spore reactivation comprising contacting spores with an effective amount of one or more green tea polyphenols (GTP), one or more modified green tea polyphenols (LTP), or a combination thereof. In a preferred embodiment, the LTP is (−)-epigallocatechin-3-gallate (EGCG) esterified at the 4′ position with stearic acid, EGCG esterified at the 4′ position with palmitic acid, or a combination thereof. The compositions and methods can be used in a variety of applications, for example, to increase the shelf-life of a food or a foodstuff, to reduce or delay the spoilage of a food or a foodstuff, or to decontaminate a device contaminated with spores.

### FIELD OF THE INVENTION

The field of the invention is generally related to compositions and methods of use thereof for killing, inactivating, or otherwise reducing spores such as bacterial spores.

### BACKGROUND OF THE INVENTION

Many antimicrobial agents (e.g., iodophors, peracids, hypochlorites, chlorine dioxide, ozone, etc.) have a broad spectrum of antimicrobial properties. However, these agents are often ineffective against spores. Killing, inactivating, or otherwise reducing the active population of spores can be difficult. Bacterial spores, for example, have a unique chemical composition of spore layers that make them more resistant than vegetative bacteria to the antimicrobial effects of chemical and physical agents. This resistance can be particularly troublesome when the spores or fungi are located on surfaces such as food, food contact sites, ware, hospitals and veterinary facilities, surgical and other medical devices, and hospital and surgical linens and garments.

For example, Bacillus cereus is frequently diagnosed as a cause of gastrointestinal disorders and has been suggested to be the cause of several food-borne illness outbreaks. Due to its rapid sporulating capacity, Bacillus cereus easily survives in the environment. It is ever-present in nature, and consequently is often found in animal feed and fodder. Bacillus cereus can contaminate raw milk via feces and soil, and can survive intestinal passage in cows and the pasteurization process. In humans, Bacillus cereus can cause serious human illness via environmental contamination. For example, Bacillus cereus is known to cause post-traumatic injury eye infections, which can result in visual impairment or loss of vision within 12-48 hours after infection. Furthermore, it is believed that Bacillus cereus can be from washed surgical garments to patients.

Therefore, it is object of the invention to provide compositions and methods of use thereof for killing, inactivating, or otherwise reducing spores.

It is a further object of the invention to provide compositions and methods of reducing or prevent spore reactivation.

It is also an object of the invention to provide compositions and methods for increasing the shelf-life or reducing spoilage of food and foodstuffs.

It is also an object of the invention to provide compositions and methods for decontaminating equipment and devices, such as food processing equipment and medical devices, which are contaminated or likely to become contaminated with spores.

### SUMMARY OF THE INVENTION

Compositions and methods for killing, inactivating, or otherwise reducing the spores are disclosed. The methods typical include reducing or preventing spore reactivation by contacting spores with an effective amount of one or more green tea polyphenols (GTP), one or more modified green tea polyphenols (LTP), or a combination thereof are disclosed. The compositions and methods can be used in a variety of applications, for example, to increase the shelf-life of a food or a foodstuff, to reduce or delay the spoilage of a food or a foodstuff, or to decontaminate a device contaminated with spores. The device can be, for example, a device used for the collection, preparation, packaging or distribution of a food or a foodstuff, or a medical device or surgical device.

The methods typically include contacting the spores with an effective amount of one or more green tea polyphenols or modified green tea polyphenols to prevent or reduce reactivation of the spores. The contacting can be for minutes, hours, days, weeks, months, or years. In some embodiments the spores are contacted with an effective amount of one or more green tea polyphenols, modified green tea polyphenols, or combinations thereof to reduce or prevent one or more hallmarks of germination or outgrowth such as an increase in metabolic activity of the spore/bacterium, rupture or absorption of the spore coat, swelling of the spore, loss of resistance to environmental stress, the core of the spore manufacturing new chemical components, exiting the old spore coat, formation of a fully functional vegetative bacterial cell, or vegetative bacterial cell division, compared to a control.

In a preferred embodiment the one or more modified green tea polyphenol is

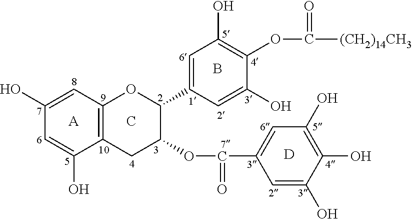

(−)-epigallocatechin-3-gallate (EGCG) esterified at the 4′ position with stearic acid (as shown), EGCG esterified at the 4′ position with palmitic acid, or a combination thereof. In other embodiments, the green tea polyphenol is esterified with C1 to C30 at least two of positions of EGCG selected from the group consisting of 5, 7, 5′, 4′, 3″, 4″, and 5″.

The one or more green tea polyphenols or modified green tea polyphenols, or combinations thereof can be part of an anti-spore composition further comprising one or more additional components. The composition can include bioactive agents, therapeutic agents, excipients, carriers, fillers, additives, binders, disintegration agents, lubricants, flavoring agents, and combinations thereof. In some embodiments, the composition is less than 1%, 1%, 2%, 5%, 10%, 25%, or more than 25% of the one or more green tea polyphenols, one or more modified green tea polyphenols, or combination thereof.

Other methods include the step of contacting the spores with an antibiotic. Still other methods include the step of activating the spores, for example, by treatment with heat, pH, or a reducing agent. The method can also include the step of contacting the spores with one or more nutritional components that can increase spore activation or germination. Exemplary nutritional components are those found in nutrient agar, sporulating agar, tryptic soy agar, or LB agar. In some embodiments, the nutritional components are part of the anti-spore composition.

### BRIEF DESCRIPTION OF THE DRAWING

FIG. 1 is a bar graph showing the percent inhibition of spore germination from B. cereus, B. megaterium, and B. subtilis treated with 10% green tea polyphenols (GTP), 10% lipid soluble green tea polyphenols (LTP), 10% (−)-epigallocatechin-3-gallate (EGCG), or (−)-epigallocatechin-3-gallate esterified with stearic acid (EGCG Stearate).

FIG. 2 is a bar graph showing the percent inhibition of spore germination from B. cereus, B. megaterium, and B. subtilis treated with 1%, 5% and 10% of EGCG, EGCG Stearate, GTP, and LTP. EGCG refers to (−)-epigallocatechin-3-gallate (EGCG), or (−)-epigallocatechin-3-gallate (EGCG) esterified with stearic acid.

FIG. 3 is a bar graph of percent inhibition of Bacillus megaterium treated with 1%, 5%, of 10% of EGCG, EGCG Stearate, GTP or LTP.

FIG. 4 is a bar graph of percent inhibition of Bacillus subtilis treated with 1%, 5%, of 10% of EGCG, EGCG Stearate, GTP or LTP.

### DETAILED DESCRIPTION OF THE INVENTION

### I. Definitions

As used herein, the singular forms “a,” “an,” and “the” include plural referents unless the context clearly dictates otherwise. Thus, for example, reference to “a factor” refers to one or mixtures of factors, and reference to “the method of treatment” includes reference to equivalent steps and methods known to those skilled in the art, and so forth.

“Acyloxy”, as used herein, refers to a substituent having the following chemical formula:

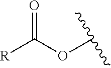

wherein R is a linear, branched, or cyclic alkyl, alkenyl, or alkynyl group.

“Alkoxy carbonyl”, as used herein, refers to a substituent having the following chemical formula:

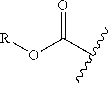

wherein R is a linear, branched, or cyclic alkyl group.

The term “alkenyl” refers to a monovalent, unbranched or branched hydrocarbon chain having one or more double bonds therein. The double bond of an alkenyl group can be unconjugated or conjugated to another unsaturated group.

The term “alkynyl” refers to a monovalent, unbranched or branched hydrocarbon chain having one or more triple bonds therein. The triple bond of an alkynyl group can be unconjugated or conjugated to another unsaturated group.

The term “cell” refers to a membrane-bound biological unit capable of replication or division.

The term “emulsion” refers to a mixture prepared from two mutually insoluble components. It is possible to generate mixtures of homogenous macroscopic appearance from these components through proper selection and manipulation of mixing conditions. The most common type of emulsions are those in which an aqueous component and a lipophilic component are employed and which in the art are frequently referred to as oil-in-water and water-in-oil emulsions. In oil-in-water emulsions the lipophilic phase is dispersed in the aqueous phase, while in water-in-oil emulsions the aqueous phase is dispersed in the lipophilic phase. Commonly known emulsion based formulations that are applied to the skin include cosmetic products such as creams, lotions, washes, cleansers, milks and the like as well as dermatological products comprising ingredients to treat skin conditions, diseases or abnormalities.

The term “host” refers to a living organism, including but not limited to a mammal such as a primate, and in particular a human.

“Hydrophilic” as used herein refers to substances that have strongly polar groups that readily interact with water.

“Hydrophobic” as used herein refers to substances that lack an affinity for water; tending to repel and not absorb water as well as not dissolve in or mix with water.

The term “isolated,” when used to describe the various compositions disclosed herein, means a substance that has been identified and separated and/or recovered from a component of its natural environment. For example an isolated polypeptide or polynucleotide is free of association with at least one component with which it is naturally associated. Contaminant components of its natural environment are materials that would typically interfere with diagnostic or therapeutic uses for the polypeptide or polynucleotide and may include enzymes, and other proteinaceous or non-proteinaceous solutes. An isolated substance includes the substance in situ within recombinant cells. Ordinarily, however, an isolated substance will be prepared by at least one purification step.

The term “Green Tea Polyphenols” and “GTP” refers to polyphenolic compounds present in the leaves of Camellia sinensis. Green tea polyphenols include, but are not limited to (−)-epicatechin (EC), (−)-epigallocatechin (EGC), (−)-epicatechin-3-gallate (ECG), (−)-epigallocatechin-3-gallate (EGCG), proanthocyanidins, enantiomers thereof, epimers thereof, isomers thereof, combinations thereof, and prodrugs thereof. Modified green tea polyphenols refers to a green tea polyphenol having one or more hydrocarbon chains, for example C₁ to C₃₀ and the compounds according to Formula I and II disclosed herein.

“Lipid soluble” as used herein refers to substances that have a solubility of greater than or equal to 5 g/100 ml in a hydrophobic liquid such as castor oil.

The term “lipid-soluble green tea polyphenol” and “LTP” refers to a green tea polyphenol having one or more hydrocarbon chains having for example C₁ to C₃₀ groups linked to the polyphenol. C₁ to C₃₀ groups include for example cholesterol. Representative lipid-soluble green tea polyphenols include those according to Formula I and Formula II disclosed herein. The term is used interchangeably with “modified green tea polyphenol”.

The term “operably linked” refers to a juxtaposition wherein the components are configured so as to perform their usual function. For example, control sequences or promoters operably linked to a coding sequence are capable of effecting the expression of the coding sequence, and an organelle localization sequence operably linked to protein will direct the linked protein to be localized at the specific organelle.

The term “prodrug” refers to an agent, including nucleic acids and proteins, which is converted into a biologically active form in vivo. Prodrugs are often useful because, in some situations, they may be easier to administer than the parent compound. They may, for instance, be bioavailable by oral administration whereas the parent compound is not. The prodrug may also have improved solubility in pharmaceutical compositions over the parent drug. A prodrug may be converted into the parent drug by various mechanisms, including enzymatic processes and metabolic hydrolysis. Harper, N.J. (1962). Drug Latentiation in Jucker, ed. Progress in Drug Research, 4:221-294; Morozowich et al. (1977). Application of Physical Organic Principles to Prodrug Design in E. B. Roche ed. Design of Biopharmaceutical Properties through Prodrugs and Analogs, APhA; Acad. Pharm. Sci.; E. B. Roche, ed. (1977). Bioreversible Carriers in Drug in Drug Design, Theory and Application, APhA; H. Bundgaard, ed. (1985) Design of Prodrugs, Elsevier; Wang et al. (1999) Prodrug approaches to the improved delivery of peptide drug, Curr. Pharm. Design, 5(4):265-287; Pauletti et al. (1997). Improvement in peptide bioavailability: Peptidomimetics and Prodrug Strategies, Adv. Drug. Delivery Rev., 27:235-256; Mizen et al. (1998). The Use of Esters as Prodrugs for Oral Delivery of β-Lactam antibiotics, Pharm. Biotech. 11, 345-365; Gaignault et al. (1996). Designing Prodrugs and Bioprecursors I. Carrier Prodrugs, Pract. Med. Chem., 671-696; M. Asgharnejad (2000). Improving Oral Drug Transport Via Prodrugs, in G. L. Amidon, P. I. Lee and E. M. Topp, Eds., Transport Processes in Pharmaceutical Systems, Marcell Dekker, p. 185-218; Balant et al. (1990) Prodrugs for the improvement of drug absorption via different routes of administration, Eur. J. Drug Metab. Pharmacokinet., 15(2): 143-53; Balimane and Sinko (1999). Involvement of multiple transporters in the oral absorption of nucleoside analogues, Adv. Drug Delivery Rev., 39(1-3):183-209; Browne (1997). Fosphenyloin (Cerebyx), Clin. Neuropharmacol., 20(1): 1-12; Bundgaard (1979). Bioreversible derivatization of drugs—principle and applicability to improve the therapeutic effects of drugs, Arch. Pharm. Chemi., 86(1): 1-39; H. Bundgaard, ed. (1985) Design of Prodrugs, New York: Elsevier; Fleisher et al. (1996). Improved oral drug delivery: solubility limitations overcome by the use of prodrugs, Adv. Drug Delivery Rev., 19(2): 115-130; Fleisher et al. (1985). Design of prodrugs for improved gastrointestinal absorption by intestinal enzyme targeting, Methods Enzymol., 112: 360-81; Farquhar D, et al. (1983). Biologically Reversible Phosphate-Protective Groups, J. Pharm. Sci., 72(3): 324-325; Han, H. K. et al. (2000). Targeted prodrug design to optimize drug delivery, AAPS PharmSci., 2(1): E6; Sadzuka Y. (2000). Effective prodrug liposome and conversion to active metabolite, Curr. Drug Metab., 1(1):31-48; D. M. Lambert (2000) Rationale and applications of lipids as prodrug carriers, Eur. J. Pharm. Sci., 11 Suppl 2:S15-27; Wang, W. et al. (1999) Prodrug approaches to the improved delivery of peptide drugs. Curr. Pharm. Des., 5(4):265-87.

The term “substituted C₁ to C₃₀” refers to an alkyl, alkenyl, or alkynyl chain of one to thirty carbons wherein one or more carbons are independently substituted with one or more groups including, but not limited to, halogen, hydroxy group, aryl group, heterocyclic group, or alkyl ester. The range C₁ to C₃₀ includes C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉ etc. up to C₃₀ as wells as ranges falling within C₁ to C₃₀, for example, C₁ to C₂₉, C₂ to C₃₀, C₃ to C₂₈, etc. The range also includes less than C₃₀, less than C₁₉, etc.

The term “treating or treatment” refers to alleviating, reducing, or inhibiting one or more symptoms or physiological aspects of a disease, disorder, syndrome, or condition.

“Water soluble” as used herein refers to substances that have a solubility of greater than or equal to 5 g /100 ml water.

The term “treating or treatment” refers to alleviating, reducing, or inhibiting one or more symptoms or physiological aspects of a disease, disorder, syndrome, or condition.

The term “foodstuff” as used herein refers to a substance with food value, and includes the raw material of food before or after processing. The term foodstuff is intended to mean a substance which is suitable for human or animal consumption, and includes dairy products (e.g., milk and cheese), animal foods (e.g., dog and cat food), snack foods (e.g., pretzels, chips, crackers), sauces and gravies, soups, casseroles, fruits, vegetables, juices, prepared meat and meat spreads, cereals, margarine, salad dressings, condiments (e.g., ketchup and mustard), meat, fish and shellfish, and poultry.

The term “pharmaceutically acceptable carrier” refers to a carrier or diluent that does not cause significant irritation to an organism and does not abrogate the biological activity and properties of the administered compound.

The term “pharmaceutically acceptable salt” refers to those salts which retain the biological effectiveness and properties of the free bases and which are obtained by reaction with inorganic or organic acids such as hydrochloric acid, hydrobromic acid, sulfuric acid, nitric acid, phosphoric acid, methanesulfonic acid, ethanesulfonic acid, p-toluenesulfonic acid, salicylic acid, malic acid, maleic acid, succinic acid, tartaric acid, citric acid, and the like.

A “anti-spore composition” refers to a mixture of one or more of the green tea polyphenols described herein, or a pharmaceutically acceptable salts thereof, with other chemical components, such as physiologically acceptable carriers and excipients.

It will be appreciated that a numerical range provided herein includes each intervening integer

### II. Methods of Preventing Spore Reactivation

It has been discovered that the green tea polyphenols and modified green tea polyphenols, combinations thereof, and compositions thereof can be used to prevent reactivation of spores. Reactivation of the spores typically occurs when conditions are more favorable to vegetative cells. The process of reactivation involves activation, germination, and outgrowth. Even if a spore is located in plentiful nutrients, it may fail to germinate unless activation has taken place. This may be triggered by heating the spore. Germination, which involves the dormant spore starting metabolic activity, can include rupture or absorption of the spore coat, swelling of the spore, an increase in metabolic activity, and loss of resistance to environmental stress. Outgrowth follows germination and involves the core of the spore manufacturing new chemical components and exiting the old spore coat to develop into a fully functional vegetative bacterial cell, which can divide to produce more cells.

A. Spore Lifecycle

Certain microorganisms are able to form spores which help them survive under harsh environmental conditions. For example, in spore-forming bacteria, when a bacterium detects environmental conditions are becoming unfavorable, it may initiate endosporulation. First, DNA is replicated and a membrane wall called a spore septum forms between it and the rest of the cell. The plasma membrane of the cell surrounds this wall and pinches off to leave a double membrane around the DNA. The developing structure is referred to as a forespore. Calcium dipicolinate is incorporated into the forespore and a peptidoglycan cortex forms between the two layers. The bacterium adds a spore coat to the outside of the forespore. The now mature endospore is released when the surrounding vegetative cell degrades.

Endospores are highly resistant to environmental challenges such temperature differences, absence of air, water and nutrients, chemicals insults, heat, mechanical disruption, UV irradiation, and enzymes. Most agents that would normally kill the vegetative cells they formed from are ineffective against spores. For example, nearly all household cleaning products, alcohols, quaternary ammonium compounds and detergents have little effect endospores. Through sporulation, bacteria can adapt to unfavorable conditions surviving for years before reactivation via spore germination and outgrowth.

B. Contacting Spores with GTP or LTP

The Examples below illustrates the green tea polyphenols and modified green tea polyphenols prevent or reduce reactivation of spores. Therefore, the disclosed methods of preventing spore reactivation typically includes contacting spores with an effective amount of one or more green tea polyphenols, one or more modified green polyphenols, or combinations thereof to reduce or prevent spore reactivation. The one or more green tea polyphenols, one or more modified green polyphenols, or combinations thereof can be part of an anti-spore composition that includes one or more additional inert or active ingredients. Therefore, in some embodiments, a method of preventing spore reactivation includes contacting spores with an effective amount of an anti-spore composition including one or more green tea polyphenols, one or more modified green polyphenols, or combinations thereof to reduce or prevent spore reactivation. The one or more green tea polyphenols, one or more modified green polyphenols, or combinations thereof, or an anti-spore composition thereof can be effective to reduce or prevent spore germination or to reduce or prevent spore outgrowth. The contacting can be for minutes, hours, days, weeks or longer. For example, in some embodiments, the contacting is for 1, 2, 3, 4, 5, 6, 12, 18, 24, 36, 48, or more minutes, hours, days, weeks, or months.

In some embodiments, the compositions kill, inactivate, or otherwise reduce the number of total spores or the number of active spores. In some embodiments, the compositions reduce or prevent one or more hallmarks of germination, outgrowth, or a combination thereof, including, but not limited to, an increase in metabolic activity of the spore/bacterium, rupture or absorption of the spore coat, swelling of the spore, loss of resistance to environmental stress, the core of the spore manufacturing new chemical components, exiting the old spore coat, formation of a fully functional vegetative bacterial cell, and vegetative bacterial cell division.

The effect of the one or more green tea polyphenols, one or more modified green polyphenols, or combinations thereof, or an anti-spore composition thereof can be compared to a control. Controls are known and understood by one of skill in the art and can include, for example, untreated spores or spores treated with an alternative anti-spore composition. An exemplary in vitro test that can used to measure spore reactivation in the presence or absence of GTP, LTP, or an anti-spore composition is described in the Examples below.

As discussed above, the methods disclosed here typically include contacting a spore with an effective amount of one or more GTP, LTP, a combination therefore, or an anti-spore composition including one or more GTP, LTP, or a combination thereof. Exemplary modified green tea polyphenols, combinations thereof, and compositions thereof are provided below. The spores can be contacted with a composition that is less than 1%, 1%, 2%, 5%, 10%, 25%, or more than 25% GTP or LTP. As illustrated in the Example below, the amount of GTP or LTP that is need to effectively reduce or prevent spore reactivation can depend on factors including the composition(s) of the GTP or LTP, the species of spores to be contacted, and the environmental conditions (i.e., temperature, availability of nutrients, etc.). The data in Example 2 below shows that, generally, increasing the percent compositions of GTP or LTP up to at least 10% corresponds with an increase in inhibition of spore germination. The data in the Examples also shows, generally, that LTP and particularly EGCg-stearate, are more effective than GTP or unmodified EGC-g at inhibiting spore germination, and can therefore be used at a lower concentration relative to GTP.

C. Inducing Activation

The methods can include one or more steps that induce the spores to begin the reactivation process. The breaking of dormancy typically involves two superimposed mechanisms (Keynan, et al., J. Bacteriology, 88(2):313-318 (1964)). The first is the reversible activation of the spore by heat or other agents, and the second is the irreversible germination process which can be induced only in the activated spore. Spores activated by storage for long periods of time can germinate upon addition of germination-inducing agents without heat treatment, but this is not reversible. Rapid and complete germination occurs only after activation, and is triggered by specific germination-inducing agents, such as L-alanine.

Therefore, in some embodiments, a method of reducing or preventing reactivation include a step of inducing activating the spore so that germination, outgrowth, or a combination thereof can be reduced or prevented using the disclosed compositions.

1. Nutrient Availability

Inducing activation can include altering the spore's environment an effective amount to induce or increase activation. For example, in some embodiments, the spores are contacted with nutrients. The nutrients can by, for example, nutrients that increase spore activation or germination. The effect of nutrient availability on sporulation is illustrated in the Example below. Table 1 shows that at 7 days the % spores is generally the highest-to-lowest in spores cultured on nutrient agar>sporulating agar>tryptic soy agar>LB agar. Therefore, some embodiments, the spores are contacted with one or more ingredients of LB agar, preferably one or more ingredients of tryptic soy agar, more preferably one or more ingredients of sporulating agar, most preferably one or more ingredients of nutrient agar. The ingredients and composition of nutrient agar, sporulating agar, tryptic soy agar, LB agar are known in the art. Nutrient agar, for example, includes 0.06 g MgSO₄ and KH₂PO₄ per liter. The nutrient ingredient or ingredients can be added to the anti-spore compositions or contacted with the spores separately prior to and/or during contact with the GTP, LTP, or anti-spore composition.

2. Heat, pH, and Reducing Agents

Even if a spore is located in plentiful nutrients, it may fail to activate. Methods of controlling spore activation are well known in the art and include changing temperature, treatment with a reducing agent, or alteration of pH, see for example, Keynan, et al., J. Bacteriology, 88(2):313-318 (1964) and Foerster, et al., Achieves of Microbiology, 134(3):175-181 (1983) both of which are specifically incorporated by reference herein in their entireties. Therefore, in some embodiments, the spores are heated, treated with a reducing agent, or subjected to an acidic pH. An exemplary heat activation step can include maintaining the spores at a temperature of 90° C. for about 20 minutes or more. Another exemplary heat activation step can include maintaining the spores at a temperature to about 65° C. for about 45 minutes or more. Another exemplary heat activation step can include maintaining the spores at a temperature of about 34° C. for about 48 hours or more.

An activation step can alternatively or additionally include contacting the spores with a reducing agent such as mercaptoethanol or thioglycolate).

An activation step can also alternatively or additionally include maintaining the spores at a pH of 4.5 or less.

D. Increasing Effectiveness of the Methods

The methods can include one or more additional steps or agents that further reduce spore reactivation.

1. Heat Treatment

For example, in some embodiments, the method includes a heat treatment. The heat treatment can, for example, include maintaining the temperature at, or above, 25, 30, 35, 40, 45, 50, 55, 60, 65, 70, 75, 80, 85, 90, 95, 100, 110, 120, 130, 140, 150, or 250° C. The treatment can be for less than one hour, for one hour, or for more than one hour. For example, the treatment can be 1, 2, 3, 4, 5, 6, 12, 18, 24, 36, 48, or more hours.

The treatment can be before, after, or concurrent with contacting the spores with the compositions disclosed herein. It is therefore appreciated that the appropriate temperature and the duration of the temperature can be selected based on the intended use. For example, a mild heat treatment, such as to between about 30 and 100° C. can be used to induce spore activation prior to or during treatment with the disclosed GTP, LTP, or anti-spore compositions thereof. In some embodiments, a heat treatment, for example above 120° C. is used during or after treatment with the disclosed GTP, LTP, or anti-spore compositions thereof to increase the spore killing ability of the disclosed composition, for example, by further reducing germination, outgrowth, or a combination thereof.

2. pH Adjustment

The method can include adjusting the pH. The pH can be adjusted to be around physiological pH (i.e. between about 7.2 and 7.6, or about 7.4). The pH can also be adjusted to be more acidic, (i.e., a pH of about 1, 2, 3, 4, 5, or 6); or more basic (i.e., a pH of about 8, 9, 10, 11, 12, 13, 14). The treatment can be for less than one hour, for one hour, or for more than one hour. For example, the treatment can be 1, 2, 3, 4, 5, 6, 12, 18, 24, 36, 48, or more hours.

The treatment can be before, after, or concurrent with contacting the spores with the compositions disclosed herein. Therefore, it will be appreciated as discussed above with respect to heat treatment, that the appropriate pH and the duration of the pH can be selected based on the intended use. For example, acidic pH, such as 4.5 or below can be selected to induce spore activation prior to or during treatment with the disclosed GTP, LTP, or anti-spore compositions thereof. In another embodiment, pH adjustment is used during or after treatment with the disclosed GTP, LTP, or anti-spore compositions thereof to increase the spore killing ability of the disclosed composition, for example, by further reducing germination, outgrowth, or a combination thereof.

3. Bleach Treatment

Although not suitable for use with edible compositions, in some antiseptic embodiments the disclosed methods of using GTP, LTP, and anti-spore compositions thereof can include a bleach, glutaraldehyde, or other disinfectant treatment. For example, a bleach treatment can include contacting spores with between about 1% and 15% bleach for between about 5 minutes and 15 minutes. In one embodiment, the spores are contacted with about 10% bleach for about 10 minutes. Spore disinfectant treatments are known in the art, see for example, Heninger, et al., Appl Biosaf., 14(1): 7-10 (2009), which is specifically incorporated by reference herein in its entirety. The treatment can be before, after, or concurrent with contacting the spores with the compositions disclosed herein.

E. Spores to be Treated

In a preferred embodiment, the disclosed compositions and methods are used to reduce or prevent reactivation of endospores. In some embodiments, the compositions and methods disclosed herein are used to reduce or prevent reactivation of exospores, such as those formed by Methylosinus. The difference between endospores and exospores is mainly in how they form. Endospores form inside the original bacterial cell, as described above. Exospores form outside by growing or budding out from one end of the cell. Exospores also do not typically have all the same components as endospores, but are similarly resistant to environment insults.

In some embodiments, the spores are cysts. Members of the Azotobacter, Bdellovibrio, Myxococcus and Cyanobacteria genera can form protective structures called cysts. Cysts are thick-walled structures that, like spores, protect bacteria from harm. Cysts can be less durable than endospores and exospores.

### III. Applications of Preventing Spore Reactivation

As discussed in more detail below, the disclosed compositions and methods can be used in various applications where it is desirable to prevent spore reactivation. For example, the one or more green tea polyphenols, one or more modified green polyphenols, or combinations thereof, or an anti-spore composition thereof can be added to or coated onto food to delay or prevent spoilage; they can be added to or coated onto equipment used to collect, process, prepare, or distribute food to reduce or prevent spore contamination of food; and they can be added to or coated onto medical devices and surgical instruments to reduce or prevent infection associated with medical interventions.

A. Methods of Preventing Food Spoilage

The modified green tea polyphenols, combinations thereof, and compositions thereof can be used to reduce or prevent food spoilage caused by spore forming bacteria. Therefore, the compositions can be used as a preservative to increase the half-life of foodstuffs. In an exemplary method, the GTP, LTP, or anti-spore composition thereof is used as a food additive to limit microbial activity and improve shelf life of a food or foodstuff. In preferred embodiments, the composition does not have an adverse effect on the flavor of the food or foodstuff (i.e., the organoleptic properties of the foodstuff are maintained or improved).

The GTP, LTP, or anti-spore composition thereof can be added or applied to the food or foodstuff in a form and method known to those skilled in the art. For example, the additive can be in the form of a powder, granular blend, or a liquid, and can be applied to or mixed with the food or foodstuff using marination, kneading, blending, tumbling, spraying, massaging, injecting, mixing and the like. The GTP, LTP, or anti-spore composition thereof can be sprayed, injected, dipped or poured directly onto products. In some embodiments the GTP, LTP, or anti-spore composition thereof are frozen and products are placed in contact with the frozen compositions. The GTP, LTP, or anti-spore composition thereof can be spray dried, freeze-dried and/or powdered and then applied to products. The compositions can be added to a finished product or may be added at any step in the production processes of a product. For example, the compositions can be added to the final product or to what becomes the final product, or in a process of making the final product, either separately or all together at once.

Any food, foodstuff, beverage or medicine in need of increased or enhanced stability or shelf life can be treated with the disclosed methods and compositions. The GTP, LTP, or anti-spore composition thereof can also be used on foods and plant species to reduce surface spore populations and used at manufacturing or processing sites handling such foods and plant species. In a preferred embodiment, the product is one that is likely to be exposed to bacteria, particularly spore-forming bacteria, or spores thereof during its collection, processing, packaging, or distribution.

Some non-limiting examples of products that can be treated or supplemented with the disclosed methods and compositions include, but are not limited to, canned, frozen, dried, or fresh fruits and vegetables or products containing the same, wines (red or white), pet foods, fruit juices, food colorings and dyes, vegetable oils, butter, meats, cereals, chewing gum, baked goods, snack foods, dehydrated potatoes, beer, animal feed, food packaging, cosmetics, rubber products, and petroleum products, cookies, crackers, beet sugar, pie dough, rice, pasta, noodles, and beans. The products can be fresh perishable materials such as meats, fish, molluscs, crustacean, poultry, dairy products, infant foods, soups, sauces wet dishes (i.e. ready meals), fruit and vegetables, eggs, seeds, leaves, etc.

Particular plant surfaces that can be treated include both harvested and growing leaves, roots, seeds, skins or shells, stems, stalks, tubers, corms, fruit, and the like.

B. Methods of Preventing Microbial Contamination

1. Collection, Preparation, and Distribution of Food

The GTP, LTP, or anti-spore composition thereof can also be used at manufacturing or processing sites handling food or foodstuffs. For example, the GTP, LTP, or anti-spore composition thereof can be used on food transport lines (e.g., as belt sprays); boot and hand-wash dip-pans; food storage facilities; anti-spoilage air circulation systems; refrigeration and cooler equipment; beverage chillers and warmers, blanchers, cutting boards, third sink areas, and meat chillers or scalding devices. The GTP, LTP, or anti-spore composition thereof can be used to treat produce transport waters such as those found in flumes, pipe transports, cutters, slicers, blanchers, retort systems, washers, and the like.

The GTP, LTP, or anti-spore composition thereof can also be used on food packaging materials and equipment. The GTP, LTP, or anti-spore composition thereof can also be used on or in ware wash machines, dishware, bottle washers, bottle chillers, warmers, third sink washers, cutting areas (e.g., water knives, slicers, cutters and saws) and egg washers. Particular treatable surfaces include packaging such as cartons, bottles, films and resins; dish ware such as glasses, plates, utensils, pots and pans; ware wash machines; exposed food preparation area surfaces such as sinks, counters, tables, floors and walls; processing equipment such as tanks, vats, lines, pumps and hoses (e.g., dairy processing equipment for processing milk, cheese, ice cream and other dairy products); and transportation vehicles.

The GTP, LTP, or anti-spore composition thereof can also be used on or in other industrial equipment and in other industrial process streams such as heaters, cooling towers, boilers, retort waters, rinse waters, aseptic packaging wash waters, and the like. The GTP, LTP, or anti-spore composition thereof can be used to treat microbes and odors in recreational waters such as in pools, spas, recreational flumes and water slides, fountains, and the like.

2. Medical Devices

In some embodiments GTP, LTP, or an anti-spore composition thereof is coated onto, or incorporated into, a medical device to reduce or prevent bacterial contamination of the device. The device can be a device that is inserted into the subject transiently, or a device that is implanted permanently.

Examples of medical devices include, but are not limited to, needles, cannulas, catheters, shunts, balloons, and implants such as stents and valves. In some embodiments, the medical device is a vascular implant such as a stent. Stents are utilized in medicine to prevent or eliminate vascular restrictions. The implants may be inserted into a restricted vessel whereby the restricted vessel is widened.

In some embodiments, the device is a surgical device. Surgical devices include, but are not limited to articulator, bone chisel, cottle cartilage crusher, bone cutter, bone distractor, ilizarov apparatus, bone drill, bone extender, bone file, bone lever, bone mallet, bone rasp, bone saw, bone skid, bone splint, bone button, caliper, cannula, catheter, cautery, clamps, curette, depressor, dilator, dissecting knife, distractor, dermatome, forceps, acanthulus or acanthabolos, hemostat, hook, lancet (scalpel), luxator, lythotome, lythotript, mallet, mouth prop, mouth gag, mammotome, needle holder, occlude, osteotome, elevator, probe, retractor, rake, rib spreader, rongeur, scissors, spatula, speculum, sponge bowl, sterilization tray, tubes, knife, mesh, needle, snare, sponge, spoon, stapler, suture, syringe, tongue depressor, tonsillotome, tooth extractor, towel clamp, towel forceps, tracheotome, tissue expander, subcutaneous inflatable balloon expander, trephine, trocar, and tweezers.

The GTP, LTP, or anti-spore composition thereof can be formulated to permit its incorporation onto the device. The composition can be included within a coating on the device. There are various coatings that can be utilized such as, for example, polymer coatings that can release the composition over a prescribed time period. The composition can be embedded directly within the medical device. In some embodiments the composition is coated onto or within the device in a delivery vehicle such as a microparticle or liposome that facilitates its release and delivery.

C. Spore-Forming Microorganisms

The spores treated with the disclosed compositions and methods are typically protective spores. In a preferred embodiment, the spores are formed by spore-forming bacteria. Examples of spore-forming bacteria include the genera: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophosphora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and Vulcanobacillus.

In a preferred embodiment, the bacteria is Baceillus, Clostridium, Sporolactobacillus, or Sporosarcina.

In another embodiment, the spore forming microorganism is not bacteria. For example, the microorganism can be Microsporidia. Microsporidia constitute a phylum (Microspora) of spore-forming unicellular parasites with over 1,500 species. Microsporidia can cause chronic, debilitating diseases and in some cases lethal infections in humans.

### IV. Compositions for Preventing Spore Reactivation

Methods of preventing spore reactivation typically include contacting spore with one or more green tea polyphenol, one or more modified green tea phenols, or combinations thereof. In some embodiments, the one or more one or more green tea polyphenol, one or more modified green tea phenols, or combinations thereof are in an anti-spore composition. The anti-spore compositions include one or more components or ingredients. The additional components or ingredients can include additional active agents, carriers, fillers, etc., as discussed in more detail below.

As discussed above, the compositions can be suitable for use as a food additive or preservative, as a pharmaceutical composition, or an antiseptic depending on the additional components or ingredients added to the composition, and one of skill in the art can select the additional components based on the intended use. For example, it will be appreciated that if the composition is to be used as a food additive or preservative any additional active or inert ingredients in the compositions should be edible. It will also be appreciated that if the composition is to be used for coating surgical or medical devices any additional active or inert components of the composition should be compatible with the intended use of the surgical or medical device, for example, introduction or implantation into or onto the body of the subject.

A. Green Tea Polyphenols and Modified Green Tea Polyphenols

Green tea polyphenols, preferably one or more green tea polyphenols modified with one or more hydrocarbon chains having C₁ to C₃₀ groups, as well as compositions having one or more green tea polyphenols, preferably one or more green tea polyphenols modified with one or more hydrocarbon chains having C₁ to C₃₀ groups, and combinations thereof are provided. Representative green tea polyphenols include, but are not limited to (−)-epigallocatechin-3-gallate, (−)-epicatechin, (−)-epigallocatechin, and (−)-epicatechin-3-gallate. Preferred modified GTPs include modified (−)-epigallocatechin-3-gallate, a pharmaceutically acceptable salt, prodrug, or derivative thereof.

A modified GTP, a derivative or a variant of a green tea polyphenol includes green tea polyphenols having chemical modifications to increase solubility or bioavailability in a host. In certain embodiments, these chemical modifications include the addition of chemical groups having a charge under physiological conditions. In other embodiments the modifications include the conjugation of the green tea polyphenol to other biological moieties such as polypeptides, carbohydrates, lipids, or a combination thereof. Preferred modifications include modifications with one or more hydrocarbon chains having C₁ to C₃₀ groups.

Another embodiment provides an anti-spore composition including one or more green tea polyphenols, modified green tea polyphenols, optionally in combination with one or more of a pharmaceutically acceptable carrier, diluent, excipient, filler, or other inert or active agents. In some embodiments, the active ingredient in the composition consists essentially of (−)-epigallocatechin-3-gallate, (−)-epigallocatechin-3-gallate modified with one or more hydrocarbon chains having C₁ to C₃₀ groups, or a combination thereof, a pharmaceutically acceptable salt or prodrug thereof. The active ingredient can be in the form a single optical isomer. Typically, one optical isomer will be present in greater than 85%, 90%, 95%, or 99% by weight compared to the other optical isomer. It will be appreciated that the composition can also include at least one additional active ingredient, for example a second therapeutic. Additional description of the disclosed pharmaceutical compositions is provided below.

Green tea polyphenols have poor solubility in lipid medium. Therefore, lipophilic tea polyphenols are also disclosed for use in lipid-soluble medium. Lipophilic tea polyphenols (LTP or Modified green tea polyphenols) can be prepared by catalytic esterification of a green tea polyphenols (GTP).

Compositions containing green tea polyphenols modified to increase the permeability of the green tea polyphenols to skin and cell membranes or increase their solubility in hydrophobic media relative to unmodified green tea polyphenols are therefore provided. Green tea polyphenols that can be modified include, but are not limited to (−)-epicatechin (EC), (−)-epigallocatechin (EGC), (−)-epicatechin-3-gallate (ECG), (−)-epigallocatechin-3-gallate (EGCG), proanthocyanidins, enantiomers thereof, epimers thereof, isomers thereof, combinations thereof, and prodrugs thereof. One embodiment provides a green tea polyphenol having an ester-linked C₁ to C₃₀ hydrocarbon chain, for example a fatty acid, at one or more positions. Another embodiment provides a green tea polyphenol having one or more cholesterol groups linked to the polyphenol. The cholesterol group can be linked for example by an ether linkage directly to the polyphenol or a C₁ to C₁₀ linker can connect the cholesterol group to the polyphenol.

Another embodiment provides a green tea polyphenol compound having one or more acyloxy groups, wherein the acyl group is C₁ to C₃₀. It is believed that the addition of alkyl, alkenyl, or alkynyl chains, for example via fatty acid esterification, to green tea polyphenols increases the stability of the green tea polyphenols and increases the solubility of the green tea polyphenols in hydrophobic media including lipids, fats, soaps, detergents, surfactants or oils compared to unmodified green tea polyphenols. Green tea polyphenols having one or more hydrocarbon chains, for example ester-linked C₁ to C₃₀ groups or C₁ to C₃₀ acyloxy groups are believed to more permeable to skin or cell membranes and thereby enable the ester-linked hydrocarbon chain containing or acyloxy containing green tea polyphenol to readily enter a cell and have a biological effect on the cell, for example modulating gene expression, compared to unmodified green tea polyphenols.

It will be appreciated that one or more hydrocarbon chains can be linked to the green tea polyphenol using linkages other than ester linkages, for example thio-linkages. Esterified green tea polyphenols can be combined with oils, detergents, surfactants, or combinations thereof to produce compositions which clean the skin and deliver green tea polyphenols to the skin. The oils, detergents, or surfactants advantageously increase the stability of green tea polyphenols by reducing contact of the green tea polyphenols with aqueous media. Certain embodiments provide single optical isomers, enantiomers, or epimers of the disclosed modified green tea polyphenols. Other embodiments provide compositions containing single optical isomers, enantiomers, or epimers or the disclosed modified green tea polyphenols.

One embodiment provides a compound according to Formula I:

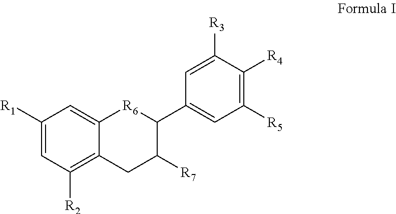

wherein R₁, R₂, R₃, R₄, R₅, and R₇ are each independently H, OH,

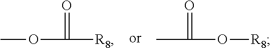

wherein R₈ is a linear, branched or cyclic, saturated or unsaturated, substituted or unsubstituted C₁-C₃₀ group, wherein if R₈ is cyclic, R₈ is a C₃-C₃₀ group; and

R₆ is O, —NR₉R₁₀, or S, wherein R₉ and R₁₀ are independently hydrogen, or a linear, branched, or cyclic, saturated or unsaturated, substituted or unsubstituted C₁-C₃₀ group, wherein if R₉ and/or R₁₀ are cyclic, R₉ and/or R₁₀ are C₃-C₃₀ groups;

wherein at least one of R₁, R₂, R₃, R₄, R₅, R₇, R₉, or R₁₀ is

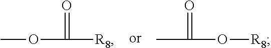

or a pharmaceutically acceptable salt or prodrug thereof, optionally in combination with an excipient.

In preferred embodiments of Formula I, R₈ is a linear or branched alkyl chain. In more preferred embodiments of Formula I, R₈ is a linear or branched C₁₆-C₂₅ alkyl group. In particularly preferred embodiments of Formula I, R₈ is a C₁₇H₃₅ group.

One embodiment provides a compound according to Formula I as described above, provided R₄ is not

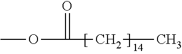

when R₁, R₂, R₃, R₅, and R₇ are OH;
or a pharmaceutically acceptable salt or prodrug thereof, optionally in combination with an excipient.

One embodiment provides a compound according to Formula I as described above wherein at least two of R₁, R₂, R₃, R₄, R₅, or R₇ are independently

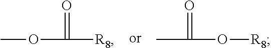

provided R₄ is not

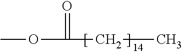

when R₁, R₂, R₃, R₅ are OH, and R₇ is

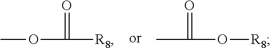

or a pharmaceutically acceptable salt or prodrug thereof, optionally in combination with an excipient.

Another embodiment provides a compound according to Formula I as described above wherein at least three of R₁, R₂, R₃, R₄, R₅, or R₇ are independently

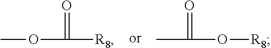

or a pharmaceutically acceptable salt or prodrug thereof, optionally in combination with an excipient.

Still another embodiment provides a compound according to Formula I as described above wherein at least four of R₁, R₂, R₃, R₄, R₅, or R₇ are independently

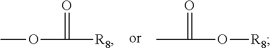

or a pharmaceutically acceptable salt or prodrug thereof, optionally in combination with an excipient.

Another embodiment provides a compound according to Formula II:

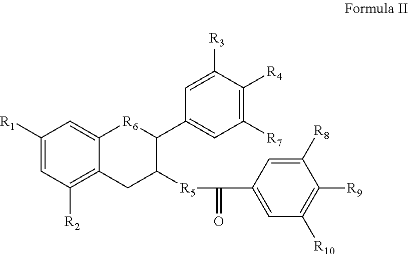

wherein R₁, R₂, R₃, R₄, R₇, R₈, R₉, and R₁₀ are each independently H, OH,

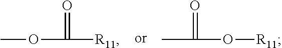

R₁₁ is a linear, branched, or cyclic, saturated or unsaturated, substituted or unsubstituted C₁-C₃₀ group, wherein if R₁₁ is cyclic, R₁₁ is a C₃-C₃₀ group;

R₅ and R₆ are independently O, —NR₁₂R₁₃ or S, wherein R₁₂ and R₁₃ are independently hydrogen, or a linear, branched, or cyclic, saturated or unsaturated, substituted or unsubstituted C₁-C₃₀ group, wherein if R₁₂ and/or R₁₃ are cyclic, R₁₂ and/or R₁₃ are C₃-C₃₀ groups; and

wherein at least one of R₁, R₂, R₃, R₄, R₇, R₈, R₉, and R₁₀ are independently

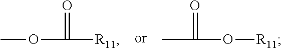

or a pharmaceutically acceptable salt or prodrug thereof, optionally in combination with an excipient.

In preferred embodiments of Formula II, R₁₁ is a linear or branched alkyl chain. In more preferred embodiments of Formula II, R₁₁ is a linear or branched C₁₆-C₂₅ alkyl group. In particularly preferred embodiments of Formula II, R₁₁ is a C₁₇H₃₅ group.

Another embodiment provides a compound according to Formula II wherein at least two of R₁, R₂, R₃, R₄, R₇, R₈, R₉, and R₁₀ are independently

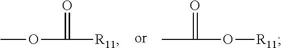

or a pharmaceutically acceptable salt or prodrug thereof, optionally in combination with an excipient.

Another embodiment provides a compound according to Formula II as described above wherein at least three of R₁, R₂, R₃, R₄, R₇, R₈, R₉, and R₁₀ are independently

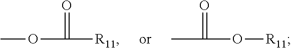

optionally in combination with an excipient.

Another embodiment provides a compound according to Formula II as described above wherein at least four of R₁, R₂, R₃, R₄, R₇, R₈, R₉, and R₁₀ are independently

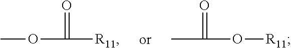

optionally in combination with an excipient.

Another embodiment provides a compound according to Formula II wherein R₁, R₂, R₃, R₄, R₇, R₈, R₉, and R₁₀ are each independently H, OH,

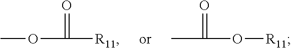

R₁₁ is a linear, branched, or cyclic, saturated or unsaturated, substituted or unsubstituted C₁-C₃₀ group, wherein if R₁₁ is cyclic, R₁₁ is a C₃-C₃₀ group;

R₅ and R₆ are independently O, —NR₁₂R₁₃ or S, wherein R₁₂ and R₁₃ are independently hydrogen, or a linear, branched, or cyclic, saturated or unsaturated, substituted or unsubstituted C₁-C₃₀ group, wherein if R₁₂ and/or R₁₃ are cyclic, R₁₂ and/or R₁₃ are C₃-C₃₀ groups; and

wherein at least one of R₁, R₂, R₃, R₄, R₇, R₈, R₉, and R₁₀ are independently

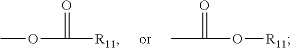

and wherein R₄ is not

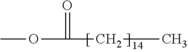

when R₁, R₂, R₃, R₇, R₈, R₉, and R₁₀ are OH;

or a pharmaceutically acceptable salt or prodrug thereof, optionally in combination with an excipient.

Another embodiment provides a composition including a compound according to Formula II wherein at least two of R₁, R₂, R₃, R₄, R₇, R₈, R₉, and R₁₀ are independently

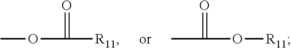

or a pharmaceutically acceptable salt or prodrug thereof, optionally in combination with an excipient.

Another embodiment provides a composition including a compound according to Formula II as described above wherein at least three of R₁, R₂, R₃, R₄, R₇, R₈, R₉, and R₁₀ are independently

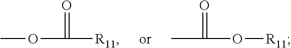

optionally in combination with an excipient.

Another embodiment provides a composition including a compound according to Formula II as described above wherein at least four of R₁, R₂, R₃, R₄, R₇, R₈, R₉, and R₁₀ are independently

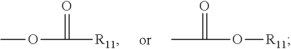

optionally in combination with an excipient.

Another embodiment provides a composition including a compound according to Formula II wherein R₁, R₂, R₃, R₄, R₇, R₈, R₉, and R₁₀ are each independently H, OH,

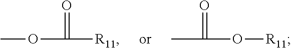

R₁₁ is a linear, branched, or cyclic, saturated or unsaturated, substituted or unsubstituted C₁-C₃₀ group, wherein if R₁₁ is cyclic, R₁₁ is a C₃-C₃₀ group;

R₅ and R₆ are independently O, —NR₁₂R₁₃ or S, wherein R₁₂ and R₁₃ are independently hydrogen, or a linear, branched, or cyclic, saturated or unsaturated, substituted or unsubstituted C₁-C₃₀ group, wherein if R₁₂ and/or R₁₃ are cyclic, R₁₂ and/or R₁₃ are C₃-C₃₀ groups; and

wherein at least one of R₁, R₂, R₃, R₄, R₇, R₈, R₉, and R₁₀ are independently

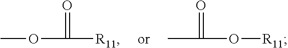

and wherein R₄ is not

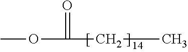

when R₁, R₂, R₃, R₇, R₈, R₉, and R₁₀ are OH;
or a pharmaceutically acceptable salt or prodrug thereof, optionally in combination with an excipient.

One embodiment provides a compound according to Formula III:

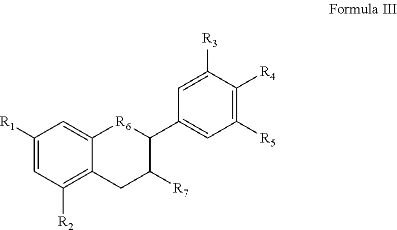

wherein R₁, R₂, R₃, R₄, R₅, and R₇ are each independently H, OH,

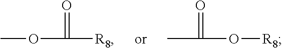

wherein R₈ is a linear or branched C₁₆-C₂₅ alkyl group.

R₆ is O, —NR₉R₁₀, or S, wherein R₉ and R₁₀ are independently hydrogen, or a linear, branched, or cyclic, saturated or unsaturated, substituted or unsubstituted C₁-C₃₀ group, wherein if R₉ and/or R₁₀ are cyclic, R₉ and/or R₁₀ are C₃-C₃₀ groups;

wherein at least one of R₁, R₂, R₃, R₄, R₅, R₇, R₉, or R₁₀ is

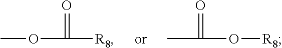

or a pharmaceutically acceptable salt or prodrug thereof, optionally in combination with an excipient.

In particularly preferred embodiments of Formula III, R₈ is a C₁₇H₃₅ group.

One embodiment provides a compound according to Formula III as described above, wherein one or more of R₁, R₂, R₃, R₄, R₅, or R₇ is

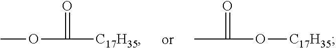

or a pharmaceutically acceptable salt or prodrug thereof, optionally in combination with an excipient.

One embodiment provides a compound according to Formula III as described above, wherein at least two of R₁, R₂, R₃, R₄, R₅, or R₇ are independently

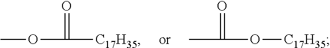

or a pharmaceutically acceptable salt or prodrug thereof, optionally in combination with an excipient.

Another embodiment provides a compound according to Formula III as described above wherein at least three of R₁, R₂, R₃, R₄, R₅, or R₇ are independently

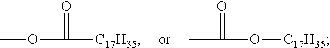

or a pharmaceutically acceptable salt or prodrug thereof, optionally in combination with an excipient.

Still another embodiment provides a compound according to Formula III as described above wherein at least four of R₁, R₂, R₃, R₄, R₅, or R₇ are independently

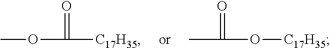

or a pharmaceutically acceptable salt or prodrug thereof, optionally in combination with an excipient.

Another embodiment provides a compound according to Formula IV:

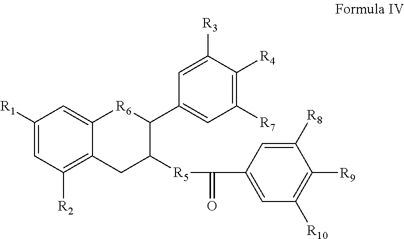

wherein R₁, R₂, R₃, R₄, R₇, R₈, R₉, and R₁₀ are each independently H, OH,

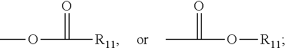

R₁₁ is a linear or branched C₁₆-C₂₅ alkyl group;

R₅ and R₆ are independently O, —NR₁₂R₁₃ or S, wherein R₁₂ and R₁₃ are independently hydrogen, or a linear, branched, or cyclic, saturated or unsaturated, substituted or unsubstituted C₁-C₃₀ group, wherein if R₁₂ and/or R₁₃ are cyclic, R₁₂ and/or R₁₃ are C₃-C₃₀ groups; and

wherein at least one of R₁, R₂, R₃, R₄, R₇, R₈, R₉, and R₁₀ are independently

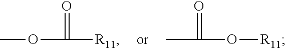

or a pharmaceutically acceptable salt or prodrug thereof, optionally in combination with an excipient.

In particularly preferred embodiments of Formula IV, R₁₁ is a C₁₇H₃₅ group.

One embodiment provides a compound according to Formula IV as described above, wherein one or more of R₁, R₂, R₃, R₄, R₇, R₈, R₉, and R₁₀ is

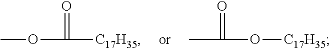

or a pharmaceutically acceptable salt or prodrug thereof, optionally in combination with an excipient.

Another embodiment provides a compound according to Formula IV wherein at least two of R₁, R₂, R₃, R₄, R₇, R₈, R₉, and R₁₀ are independently

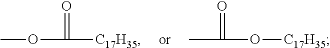

or a pharmaceutically acceptable salt or prodrug thereof, optionally in combination with an excipient.

Another embodiment provides a compound according to Formula IV as described above wherein at least three of R₁, R₂, R₃, R₄, R₇, R₈, R₉, and R₁₀ are independently

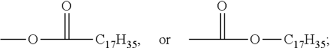

optionally in combination with an excipient.

Another embodiment provides a compound according to Formula IV as described above wherein at least four of R₁, R₂, R₃, R₄, R₇, R₈, R₉, and R₁₀ are independently

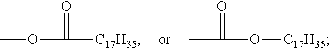

optionally in combination with an excipient.

Another embodiment provides a composition including a compound according to Formula IV wherein at least one of R₁, R₂, R₃, R₄, R₇, R₈, R₉, and R₁₀ are independently

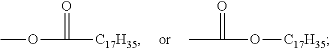

or a pharmaceutically acceptable salt or prodrug thereof, optionally in combination with an excipient.

Another embodiment provides a composition including a compound according to Formula IV wherein at least two of R₁, R₂, R₃, R₄, R₇, R₈, R₉, and R₁₀ are independently

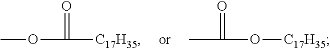

or a pharmaceutically acceptable salt or prodrug thereof, optionally in combination with an excipient.

Another embodiment provides a composition including a compound according to Formula IV as described above wherein at least three of R₁, R₂, R₃, R₄, R₇, R₈, R₉, and R₁₀ are independently

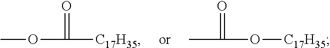

optionally in combination with an excipient.

Another embodiment provides a composition including a compound according to Formula IV as described above wherein at least four of R₁, R₂, R₃, R₄, R₇, R₈, R₉, and R₁₀ are independently

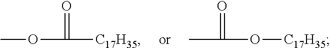

optionally in combination with an excipient.

In one embodiment, a green tea polyphenol esterified with one fatty acid is provided. Another embodiment provides a green tea polyphenol esterified with at least two fatty acids. Certain embodiments provide a green tea polyphenol esterified with one or more fatty acids having a hydrocarbon chain greater than 16 carbons. Some embodiments provide a green tea polyphenol esterified with one or more fatty acids having a hydrocarbon chain of between 17 and 25 carbons in length. Particularly preferred embodiments provide a green tea polyphenol esterified with one or more stearic acid or palmitic acid chains.

Representative green tea polyphenols include, but are not limited to (−)-epicatechin (EC), (−)-epigallocatechin (EGC), (−)-epicatechin-3-gallate (ECG), (−)-epigallocatechin-3-gallate (EGCG). Representative fatty acids include, but are not limited to butanoic acid, hexanoic acid, octanoic acid, decanoic acid, dodecanoic acid, tetradecanoic acid, hexadecanoic acid (palmitic acid), 9-hexadecenoic acid, octadecanoic acid (stearic acid), 9-octadecenoic acid, 11-octadecenoic acid, 9,12-octadecadienoic acid, 9,12,15-octadecatrienoic acid, 6,9,12-octadecatrienoic acid, eicosanoic acid, 9-eicosenoic acid, 5,8,11,14-eicosatetraenoic acid, 5,8,11,14,17-eicosapentaenoic acid, docosanoic acid, 13-docosenoic acid, 4,7,10,13,16,19-docosahexaenoic acid, and tetracosanoic acid.

B. Methods of Esterifying Green Tea Polyphenols

Lipid esters of EGCG can be formed either enzymatically or chemically (Chen, et al., Journal of Zhejiang University Science. 2003; 6:714-718).

EGCG-ester was purified previously by Chen et al in China. This was accomplished from a catalytic esterification between green tea polyphenols and C16-fatty acid. The esterification was obtained by mixing 4 grams of green tea polyphenols and 6.5 grams of hexadecanoyl chloride. Next, 50 mLs of ethyl acetate and a catalyst at 40° C. were added to the mixture. After 3 hours of stirring, the solution was washed three times with 30 mLs of deionized water. The organic layer was then allowed to evaporate and further dried by using a vacuum at 40° C. This resulted in 8.7 g of powder product. A schematic of the synthesis of a likely esterification between GTP and Hexadecanoyl Chloride is shown below. (Chen, et al., Journal of Zhejiang University Science, 2003; 6:714-718.)

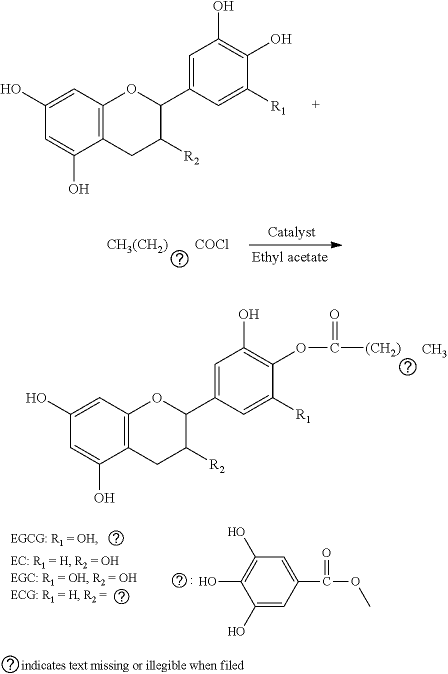

Next, high current chromatography separation was used to purify the EGCG-ester product. A two-phase solvent composed of (1:1) n-hexane-ethyl acetate-methanol-water was used in the separation column. Five grams of EGCG-ester was dissolved in 50 mL of the upper phase solution. After purification and HPLC analysis, it was seen that EGCG ester was successfully purified. The structure of an EGCG acyl-derivative is shown below. (Chen, et al., Journal of Zhejiang University Science, 2003; 6:714-718.)

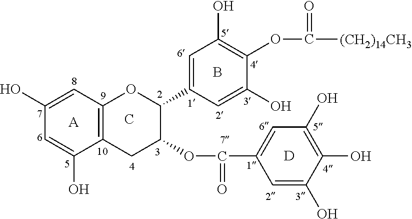

In a preferred embodiment, EGCG is esterified at the 4′ position according to the structure above with stearic acid (as shown) or palmitic acid.

C. Bioactive Ingredients

Compositions containing the disclosed green tea polyphenols optionally include one more bioactive agents or additional therapeutic agents. In certain embodiments, one or more bioactive agents can be conjugated to the green tea polyphenol. Bioactive agents include therapeutic, prophylactic and diagnostic agents. These may be organic or inorganic molecules, proteins, peptides, sugars, polysaccharides, tea saponin, vitamins, cholesterol, or nucleic acid molecules. Representative vitamins include, but are not limited to lipid soluble vitamins such as vitamin D, vitamin E, or combinations thereof. Examples of therapeutic agents include proteins, such as hormones, antigens, and growth effector molecules; nucleic acids, such as antisense molecules; and small organic or inorganic molecules such as antimicrobials, antihistamines, immunomodulators, decongestants, neuroactive agents, anesthetics, amino acids, and sedatives.

Various active agents that can be used in combination with GTP, LTP, and anti-spore compositions thereof are disclosed in U.S. Published Application Nos. 2012/0172423 and 2012/0076872 each of which are specifically incorporated by reference herein in their entities. The active agents can be, for example, anti-fungal agents, anti-bacterial agents, antiseptic agents, skin protectants, anti-psoriasis agents, local anesthetics, antihistamines, and antioxidants.

In preferred embodiment, the composition includes one or more additional antibacterial agents. A variety of known antibacterial agents can be used to prepare the described compositions. A list of potential antibacterial agents can be found in “Martindale—The Complete Drug Reference”, 32nd Ed., Kathleen Parfitt, (1999) on pages 112-270. Classes of useful antibacterials include aminoglycosides, antimycobacterials, cephalosporins and beta-lactams, chloramphenicols, glycopeptides, lincosamides, macrolides, penicillins, quinolones, sulphonamides and diaminopyridines, tetracyclines, and miscellaneous. In a preferred embodiment, the antibacterial agent is selected from the group consisting of metronidazole, timidazole, secnidazole, erythromycin, bactoban, mupirocin, neomycin, bacitracin, cicloprox, fluoriquinolones, ofloxacin, cephalexin, dicloxacillin, minocycline, rifampin, famciclovir, clindamycin, tetracycline and gentamycin.

Suitable aminoglycosides include antibiotics derived from Streptomyces and other actinomycetales, including streptomycin, framycetin, kanamycin, neomycin, paramomycin, and tobramycin, as well as gentamycin, sissomycin, netilmycin, isepamicin, and micronomycin.

Suitable antimycobacterials include rifamycin, rifaximin, rifampicin, rifabutinisoniazid, pyrazinamide, ethambutol, streptomycin, thiacetazone, aminosalicylic acid, capreomycin, cycloserine, dapsone, clofazimine, ethionamide, prothionamide, ofloxacin, and minocycline.

Cephalosporins and beta-lactams generally have activity against gram-positive bacteria and newer generations of compounds have activity against gram-negative bacteria as well. Suitable cephalosporins and beta-lactams include:

First generation; cephalothin, cephazolin, cephradine, cephaloridine, cefroxadine, cephydroxil, cefatrizine, cephalexin, pivcephalexin, cefaclor, and cefprozil.

Second generation; cephamandole, cefuroxime axetil, cefonicid, ceforanide, cefotiam, and cephamycin.

Third generation; cefotaxime, cefmenoxime, cefodizime, ceftizoxime, ceftriaxone, cefixime, cefdinir, cefetamet, cefpodoxime, ceftibuten, latamoxef, ceftazidime, cefoperazone, cefpiramide, and cefsulodin.

Fourth generation: cefepime and cefpirome

Other cephalosporins include cefoxitim, cefmetazole, cefotetan, cefbuperazone, cefminox, imipenem, meropenem, aztreonam, carumonam, and loracarbef.

Chloramphenicols inhibit gram positive and gram negative bacteria.

Suitable cloramphenicols include chloramphenicol, its sodium succinate derivative, thiamphenicol, and azidamfenicol.

Suitable glycopeptides include vancomycin, teicoplanin, and ramoplanin. Suitable lincosamides include lincomycin and clindamycin, which are used to treat primarily aerobic infections.

Macrolides have a lactam ring to which sugars are attached. Suitable macrolides include erytjhromycin, as well as spiromycin, oleandomycin, josamycin, kitamycin, midecamycin, rokitamycin, azithromycin, clarithromycin, dirithromycin, roxithromycin, flurithromycin, tylosin; and streptgramins (or synergistins) including pristinamycin, and virginiamycin; and combinations thereof.

Suitable penicillins include natural penicillin and the semisynthetic penicillins F, G, X, K, and V. Newer penicillins include phenethicillin, propicillin, methicilin, cloxacillin, dicloxacillin, flucloxacillin, oxacillin, nafcillin, ampicillin, amoxicillin, bacampicillin, hetacillin, metampicillin, pivampicillin, carbenecillin, carfecillin, carindacillin, sulbenecillin, ticarcillin, azlocillin, mezlocillin, piperacillin, temocillin, mecillinam, and pivemecillinam. Lactamase inhibitors such as clavulanic acid, sulbactam, and tazobacytam are often co-administered.

Suitable quinolones include nalidixic acid, oxolinic acid, cinoxacin, acrosoxacin, pipemedic acid, and the fluoroquinolones flumequine, ciprofloxacin, enoxacin, fleroxacin, grepafloxacin, levofloxacin, lomefloxacin, nadifloxacin, norfloxacin, ofloxacin, pefloxacin, rufloxacin, sparfloxacin, trovafloxacin, danofloxacin, enrofloxacin, and marbofloxacin.

Sulphonamides and diaminopyridines include the original of the “sulfa” drugs, sulphanilamide, and a large number of derivatives, including sulfapyridine, sulfadiazine, sulfafurazole, sulfamethoxazole, sulfadimethoxine, sulfadimethoxydiazine, sulfadoxine, sulfametopyrazine, silver sulfadiazine, mafenide acetate, and sulfasalizine, as well as related compounds including trimethoprim, baquiloprim, brodimoprim, ormetoprim, tetroxoprim, and in combinations with other drugs such as co-trimoxazole.

Tetracyclines are typically broad-spectrum and include the natural products chlortetracycline, oxytetracycline, tetracycline, demeclocycline, and semisynthetic methacycline, doxycycline, and minocycline.

Suitable antibacterial agents that do not fit into one of the categories above include spectinomycin, mupirocin, newmycin, fosfomycin, fusidic acid, polymixins, colistin, bacitracin, gramicidin, tyrothricin, clioquinol, chloroquinaldol, haloquinal, nitrofurantonin, nitroimidazoles (including metronizole, timidazole and secnidazole), and hexamine.

The antibiotic and antifungal agents may be present as the free acid or free base, a pharmaceutically acceptable salt, or as a labile conjugate with an ester or other readily hydrolysable group, which are suitable for complexing with the ion-exchange resin to produce the resinate.

D. Additional Components

In some embodiments, the composition include one or more excipients, carriers, fillers, additives, binders, disintegration agents, lubricants, flavoring agents, and combinations thereof.

For example, in certain embodiments, a composition can include one or more of the following: a binder, such as, for example, gum tragacanth, acacia, cornstarch, gelatin or combinations thereof an excipient, such as, for example, dicalcium phosphate, mannitol, lactose, starch, magnesium stearate, sodium saccharine, cellulose, magnesium carbonate or combinations thereof; a disintegrating agent, such as, for example, corn starch, potato starch, alginic acid or combinations thereof; a lubricant, such as, for example, magnesium stearate; a sweetening agent, such as, for example, sucrose, lactose, saccharin or combinations thereof; a flavoring agent, such as, for example peppermint, oil of wintergreen, cherry flavoring, orange flavoring, etc.; or combinations thereof.

Typical formulae for compositions are well known in the art. In addition to proteinaceous and farinaceous materials, the compositions of the invention generally may include vitamins, minerals, and other additives such as flavorings, preservatives, emulsifiers and humectants. Other exemplary ingredients include animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, prebiotics, probiotics, aroma modifiers, textured wheat protein, textured soy protein, textured lupin protein, textured vegetable protein, breading, comminuted meat, flour, comminuted pasta, water, and combinations thereof.

If the composition is intended to be ingested by a subject, the nutritional balance, including the relative proportions of vitamins, minerals, protein, fat and carbohydrate, and other components can be determined according to dietary standards known in the veterinary and nutritional art.

In embodiments where the composition is in a liquid form, a carrier can be a solvent or dispersion medium. Exemplary carriers include, but are not limited to, water, ethanol, polyol (e.g., glycerol, propylene glycol, liquid polyethylene glycol, etc.), lipids (e.g., triglycerides, vegetable oils, liposomes) and combinations thereof. The proper fluidity can be maintained, for example, by the use of a coating, such as lecithin; by the maintenance of the required particle size by dispersion in carriers such as, for example liquid polyol or lipids; by the use of surfactants such as, for example hydroxypropyl cellulose; or combinations thereof such methods. In many cases, it will be preferable to include isotonic agents, such as, for example, sugars, sodium chloride or combinations thereof.

Also useful herein, as an optional ingredient, is a filler. The filler can be a solid, a liquid or packed air. The filler can be reversible (for example thermo-reversible including gelatin) and/or irreversible (for example thermo-irreversible including egg white). Non limiting examples of the filler include gravy, gel, jelly, aspic, sauce, water, air (for example including nitrogen, carbon dioxide, and atmospheric air), broth, and combinations thereof.

Additional suitable compounds, agents, and ingredients that can be used in combination with GTP, LTP, and anti-spore compositions thereof are found in U.S. Published Application Nos. 2013/0035361, 2012/0251700, 2011/0207818, 2009/0297672, and 2009/0196939.

E. Pharmaceutical Compositions and Formulations

Formulations of the compounds disclosed herein including GTP and LTP can be prepared using pharmaceutically acceptable excipients composed of materials. It will be appreciated that the pharmaceutical compositions and formulations disclosed herein are considered safe and effective and can be administered to an individual without causing undesirable biological side effects or unwanted interactions. Therefore, in some embodiments, the pharmaceutical compositions are administered to a subject. In some embodiments, the pharmaceutical composition is added to a food or foodstuff to reduce or prevent spoilage or contamination of the food, or used applied in or onto equipment or devices to reduce or prevent contamination. Therefore, in some embodiments, the pharmaceutical compositions not intended to treat a disease or disorder in a subject. In some embodiments, the pharmaceutical compositions is not administered to a subject at all.

1. Excipients

As generally used herein “excipient” includes, but is not limited to, surfactants, emulsifiers, emulsion stabilizers, emollients, buffers, solvents and preservatives. Preferred excipients include surfactants, especially non-ionic surfactants; emulsifying agents, especially emulsifying waxes; and liquid non-volatile non-aqueous materials, particularly glycols such as propylene glycol. The oil phase may contain other oily pharmaceutically approved excipients. For example, materials such as hydroxylated castor oil or sesame oil may be used in the oil phase as surfactants or emulsifiers.

a. Emollients

Suitable emollients include those generally known in the art and listed in compendia, such as the “Handbook of Pharmaceutical Excipients”, 4^{th} Ed., Pharmaceutical Press, 2003. These include, without limitation, almond oil, castor oil, ceratonia extract, cetostearoyl alcohol, cetyl alcohol, cetyl esters wax, cholesterol, cottonseed oil, cyclomethicone, ethylene glycol palmitostearate, glycerin, glycerin monostearate, glyceryl monooleate, isopropyl myristate, isopropyl palmitate, lanolin, lecithin, light mineral oil, medium-chain triglycerides, mineral oil and lanolin alcohols, petrolatum, petrolatum and lanolin alcohols, soybean oil, starch, stearyl alcohol, sunflower oil, xylitol and combinations thereof. In one embodiment, the emollients are ethylhexylstearate and ethylhexyl palmitate.

b. Surfactants

Suitable surfactants include anionic surfactants, nonionic surfactants, cationic surfactants and ampholytic surfactants. Anionic surfactants include alkaline salts, ammonium salts, amine salts, amino alcohol salts and magnesium salts of the following compounds: alkyl sulphates, alkyl ether sulphates, alkylamido ether sulphates, alkylaryl polyether sulphates, monoglyceride sulphates; alkyl sulphonates, alkylamide sulphonates, alkylaryl sulphonates, olefin sulphonates, paraffin sulphonates; alkyl sulphosuccinates, alkyl ether sulphosuccinates, alkylamide sulphosuccinates; alkyl sulphosuccinamates; alkyl sulphoacetates; alkyl phosphates, alkyl ether phosphates; acyl sarcosinates, acyl isethionates and N-acyl taurates. The alkyl or acyl group in these various compounds generally consists of a carbon-based chain containing from 8 to 30 carbon atoms.

Suitable anionic surfactants include fatty acid salts such as oleic, ricinoleic, palmitic and stearic acid salts; coconut oil acid or hydrogenated coconut oil acid; acyl lactylates, in which the acyl group contains from 8 to 30 carbon atoms.

Surfactants considered as weakly anionic can also be used, such as polyoxyalkylenated carboxylic alkyl or alkylaryl ether acids or salts thereof, polyoxyalkylenated carboxylic alkylamido ether acids or salts thereof, and alkyl D-galactosiduronic acids or salts thereof.

Suitable amphoteric surfactants are secondary or tertiary aliphatic amine derivatives, in which the aliphatic radical is a linear or branched chain containing 8 to 22 carbon atoms and which contains at least one carboxylate, sulphonate, sulphate, phosphate or phosphonate water-solubilizing anionic group; (C₈-C₂₀) alkylbetaines, sulphobetaines, (C₈-C₂₀) alkyl-amido (C₁-C₆) alkylbetaines or (C₈-C₂₀) alkyl-amido (C₁-C₆) alkylsulphobetaines. The nonionic surfactants are chosen more particularly from polyethoxylated, polypropoxylated or polyglycerolated fatty acids or alkylphenols or alcohols, with a fatty chain containing 8 to 30 carbon atoms, the number of ethylene oxide or propylene oxide groups being between 2 and 50 and the number of glycerol groups being between 2 and 30.

Disodium cocoamphodiacetate, disodium lauroamphodiacetate, disodium capryloamphodiacetate, disodium caproamphodiacetate, disodium cocoampho-dipropionate, disodium lauroamphodipropionate, disodium caproamphodipropionate, disodium capryloamphodipropionate, lauroamphodipropionate acid, and cocoamphodipropionate acid can also be used.

Representative cationic surfactants are chosen in particular from optionally polyoxyalkylenated primary, secondary or tertiary fatty amine salts; quaternary ammonium salts; imidazoline derivatives; or amine oxides of cationic nature.

Suitable quaternary ammonium salts are tetraalkylammonium halides (for example chlorides) such as, for example, dialkyldimethylammonium or alkyltrimethylammonium chlorides, in which the alkyl radical contains from about 12 to 22 carbon atoms, in particular behenyltrimethylammonium, distearyl-dimethylammonium, cetyltrimethylammonium or benzyl-dimethylstearylammonium chloride or alternatively the stearamidopropyldimethyl(myristyl acetate)ammonium chloride.

Diacyloxyethyldimethylammonium, diacyloxyethylhydroxyethylmethylammonium, monoacyloxyethyldihydroxyethylmethylammonium, triacyloxyethylmethylammonium and monoacyloxyethylhydroxyethyldimethylammonium salts (chlorides or methyl sulphate in particular) and mixtures thereof can also be used. The acyl groups preferably contain 14 to 18 carbon atoms and are more particularly obtained from a plant oil such as palm oil or sunflower oil.

Additional surfactants that can be used include, but are not limited to sodium dodecylsulfate (SDS), sodium cholate, sodium deoxycholate (DOC), N-lauroylsarcosine sodium salt, lauryldimethylamine-oxide (LDAO), cetyltrimethylammoniumbromide (CTAB), and bis(2-ethylhexyl)sulfosuccinate sodium salt.

Additional non-ionic surfactants include emulsifying wax, glyceryl monooleate, polyoxyethylene alkyl ethers, polyoxyethylene castor oil derivatives, polysorbate, sorbitan esters, benzyl alcohol, benzyl benzoate, cyclodextrins, glycerin monostearate, poloxamer, povidone and combinations thereof. In one embodiment, the non-ionic surfactant is stearyl alcohol.

Representative detergents include but are not limited to alkylbenzyldimethylammonium chloride, alkyldimethylbenzylammonium chloride, sodium bis(2-ethylhexyl) sulfosuccinate, bis(2-ethylhexyl) sulfosuccinate sodium salt, 3-[(3-Cholamidopropyl)dimethylammonio]-1-propanesulfonate.

c. Emulsifiers

Suitable emulsifiers include acacia, anionic emulsifying wax, calcium stearate, carbomers, cetostearyl alcohol, cetyl alcohol, cholesterol, diethanolamine, ethylene glycol palmitostearate, glycerin monostearate, glyceryl monooleate, hydroxpropyl cellulose, hypromellose, lanolin, hydrous, lanolin alcohols, lecithin, medium-chain triglycerides, methylcellulose, mineral oil and lanolin alcohols, monobasic sodium phosphate, monoethanolamine, nonionic emulsifying wax, oleic acid, poloxamer, poloxamers, polyoxyethylene alkyl ethers, polyoxyethylene castor oil derivatives, polyoxyethylene sorbitan fatty acid esters, polyoxyethylene stearates, propylene glycol alginate, self-emulsifying glyceryl monostearate, sodium citrate dehydrate, sodium lauryl sulfate, sorbitan esters, stearic acid, sunflower oil, tragacanth, triethanolamine, xanthan gum and combinations thereof. In one embodiment, the emulsifier is glycerol stearate.

d. Buffers

Buffers preferably buffer the composition from a pH of about 4 to a pH of about 7.5, more preferably from a pH of about 4 to a pH of about 7, and most preferably from a pH of about 5 to a pH of about 7.

The disclosed compositions can also contain at least one adjuvant chosen from the adjuvants usually used in cosmetics, such as fragrances, preserving agents, sequestering agents, wetting agents, sugars, amphoteric polymers, menthol, nicotinate derivatives, agents for preventing hair loss, foam stabilizers, propellants, dyes, vitamins or provitamins, acidifying or basifying agents or other well-known cosmetic adjuvants.

2. Encapsulation

In another embodiment, the green tea polyphenols can be incorporated into a polymeric component by encapsulation in a microcapsule. The microcapsule can be fabricated from a material different from that of the bulk of the carrier, coating, or matrix. Suitable microcapsules are those which are fabricated from a material that undergoes erosion in the host, or those which are fabricated such that they allow the green tea polyphenol to diffuse out of the microcapsule. Such microcapsules can be used to provide for the controlled release of the encapsulated green tea polyphenol from the microcapsules.

Numerous methods are known for preparing microparticles of any particular size range. In the various delivery vehicles of the present invention, the microparticle sizes may range from about 0.2 μm up to about 100 μm. Synthetic methods for gel microparticles, or for microparticles from molten materials are known, and include polymerization in emulsion, in sprayed drops, and in separated phases. For solid materials or preformed gels, known methods include wet or dry milling or grinding, pulverization, size separation by air jet, sieve, and the like.

Microparticles can be fabricated from different polymers using a variety of different methods known to those skilled in the art. Exemplary methods include those set forth below detailing the preparation of polylactic acid and other microparticles. Polylactic acid microparticles are preferably fabricated using one of three methods: solvent evaporation, as described by Mathiowitz, et al. (1990) J. Scanning Microscopy 4:329; Beck, et al. (1979) Fertil. Steril. 31: 545; and Benita, et al. (1984) J. Pharm. Sci. 73: 1721; hot-melt microencapsulation, as described by Mathiowitz, et al., Reactive Polymers 6: 275 (1987); and spray drying. Exemplary methods for preparing microencapsulated bioactive materials are set forth below.

In the solvent evaporation method, the microcapsule polymer is dissolved in a volatile organic solvent, such as methylene chloride. The green tea polyphenol (either soluble or dispersed as fine particles) is added to the solution, and the mixture is suspended in an aqueous solution that contains a surface active agent such as poly(vinyl alcohol). The resulting emulsion is stirred until most of the organic solvent has evaporated, leaving solid microparticles. The solution is loaded with the green tea polyphenol and suspended in vigorously stirred distilled water containing poly(vinyl alcohol) (Sigma). After a period of stirring, the organic solvent evaporates from the polymer, and the resulting microparticles are washed with water and dried overnight in a lyophilizer. Microparticles with different sizes (1-1000 μm) and morphologies can be obtained by this method. This method is useful for relatively stable polymers like polyesters and polystyrene. Labile polymers such as polyanhydrides, may degrade during the fabrication process due to the presence of water. For these polymers, the following two methods, which are performed in completely anhydrous organic solvents, are preferably used.

In the hot melt encapsulation method, the polymer is first melted and then mixed with the solid particles of biologically active material that have preferably been sieved to less than 50 microns. The mixture is suspended in a non-miscible solvent (like silicon oil) and, with continuous stirring, heated to about 5° C. above the melting point of the polymer. Once the emulsion is stabilized, it is cooled until the polymer particles solidify. The resulting microparticles are washed by decantation with a solvent such as petroleum ether to give a free-flowing powder. Microparticles with sizes ranging from about 1 to about 1000 microns are obtained with this method. The external surfaces of capsules prepared with this technique are usually smooth and dense. This procedure is preferably used to prepare microparticles made of polyesters and polyanhydrides.

The solvent removal technique is preferred for polyanhydrides. In this method, the green tea polyphenol is dispersed or dissolved in a solution of the selected polymer in a volatile organic solvent like methylene chloride. This mixture is suspended by stirring in an organic oil (such as silicon oil) to form an emulsion. Unlike solvent evaporation, this method can be used to make microparticles from polymers with high melting points and different molecular weights. Microparticles that range from about 1 to about 300 μm can be obtained by this procedure. The external morphology of spheres produced with this technique is highly dependent on the type of polymer spray drying, the polymer is dissolved in methylene chloride. A known amount of the green tea polyphenol is suspended or co-dissolved in the polymer solution. The solution or the dispersion is then spray-dried. Microparticles ranging between about 1 to about 10 μm are obtained with a morphology which depends on the type of polymer used.

In one embodiment, the green tea polyphenol is encapsulated in microcapsules that comprise a sodium alginate envelope. Microparticles made of gel-type polymers, such as alginate, are produced through traditional ionic gelation techniques. The polymers are first dissolved in an aqueous solution, mixed with barium sulfate or some bioactive agent, and then extruded through a microdroplet forming device, which in some instances employs a flow of nitrogen gas to break off the droplet. A slowly stirred (approximately 100-170 RPM) ionic hardening bath is positioned below the extruding device to catch the forming microdroplets. The microparticles are left to incubate in the bath for about twenty to thirty minutes in order to allow sufficient time for gelation to occur. Microparticle size is controlled by using various size extruders or varying either the nitrogen gas or polymer solution flow rates.

Liposomes can aid in the delivery of the green tea polyphenol to a particular tissue and also can increase the half-life of green tea polyphenol. Liposomes are commercially available from a variety of suppliers. Alternatively, liposomes can be prepared according to methods known to those skilled in the art, for example, as described in Eppstein et al., U.S. Pat. No. 4,522,811. In general, liposomes are formed from standard vesicle-forming lipids, which generally include neutral or negatively charged phospholipids and a sterol, such as cholesterol. The selection of lipids is generally guided by consideration of factors such as the desired liposome size and half-life of the liposomes in the blood stream. A variety of methods are known for preparing liposomes, for example as described in Szoka et al., Ann. Rev. Biophys. Bioeng. 9: 467 (1980); and U.S. Pat. Nos. 4,235,871, 4,501,728, 4,837,028, and 5,019,369. In one embodiment, the liposomes encapsulating the green tea polyphenol include a ligand molecule that can target the liposome to a particular cell or tissue at or near the site of HSV infection.

In one embodiment, the liposomes encapsulating the green tea polyphenols of the present disclosure are modified so as to avoid clearance by the mononuclear macrophage and reticuloendothelial systems, for example by having opsonization-inhibition moieties bound to the surface of the structure. In one embodiment, a liposome can comprise both opsonization-inhibition moieties and a ligand. Opsonization-inhibiting moieties for use in preparing the liposomes in one embodiment are large hydrophilic polymers that are bound to the liposome membrane. As used herein, an opsonization inhibiting moiety is “bound” to a liposome membrane when it is chemically or physically attached to the membrane, e.g., by the intercalation of a lipid-soluble anchor into the membrane itself, or by binding directly to active groups of membrane lipids. These opsonization-inhibiting hydrophilic polymers form a protective surface layer which significantly decreases the uptake of the liposomes by the macrophage-monocyte system (“MMS”) and reticuloendothelial system (“RES”); e.g., as described in U.S. Pat. No. 4,920,016. Liposomes modified with opsonization-inhibition moieties thus remain in the circulation much longer than unmodified liposomes. For this reason, such liposomes are sometimes called “stealth” liposomes. Stealth liposomes are known to accumulate in tissues fed by porous or “leaky” microvasculature. In addition, the reduced uptake by the RES lowers the toxicity of stealth liposomes by preventing significant accumulation in the liver and spleen.

Opsonization inhibiting moieties suitable for modifying liposomes are preferably water-soluble polymers with a molecular weight from about 500 to about 40,000 daltons, and more preferably from about 2,000 to about 20,000 daltons. Such polymers include polyethylene glycol (PEG) or polypropylene glycol (PPG) derivatives; e.g., methoxy PEG or PPG, and PEG or PPG stearate; synthetic polymers such as polyacrylamide or poly N-vinyl pyrrolidone; linear, branched, or dendrimeric polyamidoamines; polyacrylic acids; polyalcohols, e.g., polyvinylalcohol and polyxylitol to which carboxylic or amino groups are chemically linked, as well as gangliosides, such as ganglioside GM1. Copolymers of PEG, methoxy PEG, or methoxy PPG, or derivatives thereof, are also suitable. In addition, the opsonization inhibiting polymer can be a block copolymer of PEG and either a polyamino acid, polysaccharide, polyamidoamine, polyethyleneamine, or polynucleotide. The opsonization inhibiting polymers can also be natural polysaccharides containing amino acids or carboxylic acids, e.g., galacturonic acid, glucuronic acid, mannuronic acid, hyaluronic acid, pectic acid, neuraminic acid, alginic acid, carrageenan; laminated polysaccharides or oligosaccharides (linear or branched); or carboxylated polysaccharides or oligosaccharides, e.g., reacted with derivatives of carbonic acids with resultant linking of carboxylic groups. Preferably, the opsonization-inhibiting moiety is a PEG, PPG, or derivatives thereof. Liposomes modified with PEG or PEG-derivatives are sometimes called “PEGylated liposomes.” The opsonization inhibiting moiety can be bound to the liposome membrane by any one of numerous well-known techniques. For example, an N-hydroxysuccinimide ester of PEG can be bound to a phosphatidyl-ethanolamine lipid-soluble anchor, and then bound to a membrane. Similarly, a dextran polymer can be derivatized with a stearylamine lipid-soluble anchor via reductive amination using Na(CN)BH3 and a solvent mixture such as tetrahydrofuran and water in a 30:12 ratio at 60° C.

The disclosed microparticles and liposomes and methods of preparing microparticles and liposomes are offered by way of example and are not intended to define the scope of microparticles or liposomes of use in the present disclosure. It will be apparent to those of skill in the art that an array of microparticles or liposomes, fabricated by different methods, are of use in the present invention.

### EXAMPLES

### Materials and Methods

Bacillus megaterium spores were induced through process of starvation for 2 hours in sterile deionized water and then heated at 90° C. for 20 minutes. The heated samples were treated with 10% of EGCG or EGCG-ester for 1 hour or 24 hours respectively and then plated onto nutrient agar plates with a countable range of 150 to 300 CPU (colony counting unit). The non-starved cells and starved cells without treatment were used as controls.

### Results

Green Tea is derived from the leaves of the plant Camellia sinensis. These leaves contain antioxidant ingredient catechins also known as green tea polyphenols (GTPs). Out of all catechin compounds, EGCG has powerful anti-tumor, anti-viral, and anti-bacterial activities. In this study, EGCG and EGCG-ester prepared by esterification of GTP were used to study their effect on endospores of Bacillus megaterium.

The viability of Bacillus megaterium spores in 10% EGCG or EGCG-ester treated samples showed 90% inhibition compared to the control after 24 hours-incubation at 37° C. Results: In both 1 hour and 24 hours treated samples. In the presence of 10% EGCG-ester or EGCG, no viable cells or colonies of Bacillus megaterium were detected. The results for both 1 hour and 24 hours treated samples were very similar, indicating that they are effective at inhibiting growth of bacterial spores. These data indicate that EGCG and EGCG-ester could potentially be useful in the food industry as a means of preventing food spoilage caused by spore-forming bacteria. This could also be used as antiseptics to prevent spore contamination in medical devices.

### Example 2

### Green Tea Polyphenols Inhibit Endospore Germination

### Materials and Methods

Heated samples were treated with 1, 5, 10% of GTP (mixed green tea polyphenols), LTP (lipophilic green tea polyphenols), EGCg (epigallocatechingallate), or EGCg-Stearate for 2 hours, diluted and plated onto nutrient agar plates, and incubated at 37° C. for 24 hours. Non-starved cells and starved cells without treatment were used as controls.

### Results

Germination, specifically outgrowth, of purified endospores in Bacillus cereus, B. megaterium, and B. subtilis was studied by treating the bacteria with four different green tea polyphenols: GTP (mixed green tea polyphenols), LTP (lipophilic green tea polyphenols), EGCg (epigallocatechingallate), and EGCg-Stearate.

A comparison of spore crop in various media is provided in Table 1.

TABLE 1
Comparison of Spore Crop Media.

| Type of | Day 7 (% spores) | | | | | |
|---|---|---|---|---|---|---|
| Agar | Hem 1 | Hem 2 | Hem 3 | Hem 4 | Hem 5 | Hem Avg |
| Tryptic Soy | 68.9% | 64.9% | 68.7% | 67.7% | 69.7% | 68.0% |
| Nutrient* | 93.8% | 96.2% | 97.1% | 100.0% | 95.5% | 96.5% |
| Sporulating | 95.0% | 95.0% | 95.0% | 95.0% | 95.0% | 95.0% |
| LB | 32.2% | 14.0% | 29.4% | 29.1% | 32.7% | 27.5% |

Table 2 shows the result of various concentration of GTP, LTP, EGCG and EGCG-stearate on spore outgrowth.

TABLE 2
Average Inhibition of Spore Germination by Polyphenols.

| | B. cereus | B. megaterium | B. subtilis |
|---|---|---|---|
| 1% GTP | 35.1% | 82.3% | 8.8% |
| 5% GTP | 57.0% | 88.3% | 78.3% |
| 10% GTP | 70.8% | 91.1% | 75.8% |
| 1% LTP | 76.9% | 94.9% | −7.4% |
| 5% LTP | 58.0% | 95.2% | 86.0% |
| 10% LTP | 88.5% | 96.9% | 97.3% |
| 1% EGCg | 16.9% | n/a | 52.9% |
| 5% EGCg | 25.7% | n/a | 45.1% |
| 10% EGCg | 33.0% | 100.0% | 66.1% |
| 1% EGCg-Stearate | 72.6% | 70.5% | 55.0% |
| 5% EGCg-Stearate | 56.6% | 75.0% | 58.1% |
| 10% EGCg-Stearate | 90.5% | 79.0% | 69.2% |

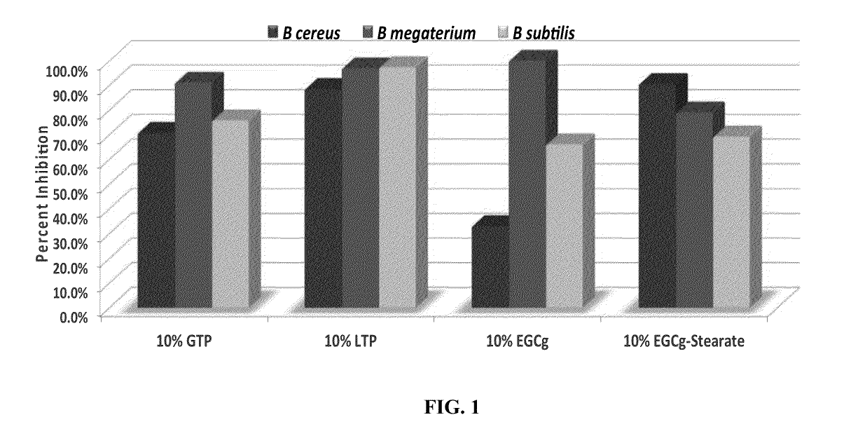

FIG. 1 is a bar graph illustrating some of the results.

GTP refers to Green Tea Polyphenols, catechins (polyphenols) extracted from tea leaves in their natural form, including EGCG, ECG, EGC and EC. It is a mixture of these compounds without additional processing. LTP refers to Lipophilic Tea Polyphenols, made from GTP using ester linkage to fatty acid such as stearate or palmitate. LTP is a mixture of esters of EGCG, ECG, EGC, and EC from the chemical reaction and are examples of “modified green tea polyphenols”.

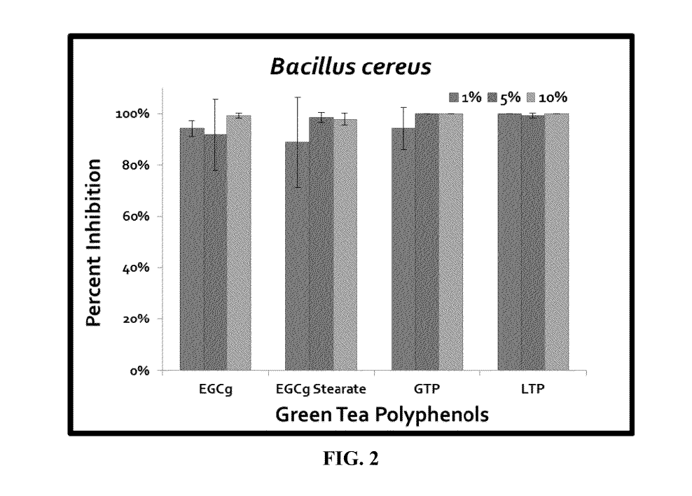

FIG. 2 is a bar graph of percent inhibition of Bacillus cereus treated with 1%, 5%, of 10% of EGCG, EGCG Stearate, GTP or LTP.

TABLE 3
Average Percent Inhibition of B. cereus

| Concentration | EGCg | EGCg-Stearate | GTP | LTP |
|---|---|---|---|---|
| 1% | 94.18% | 88.81% | 94.21% | 100% |
| 5% | 91.68% | 98.49% | 100% | 99.28% |
| 10% | 99% | 98% | 100% | 100% |

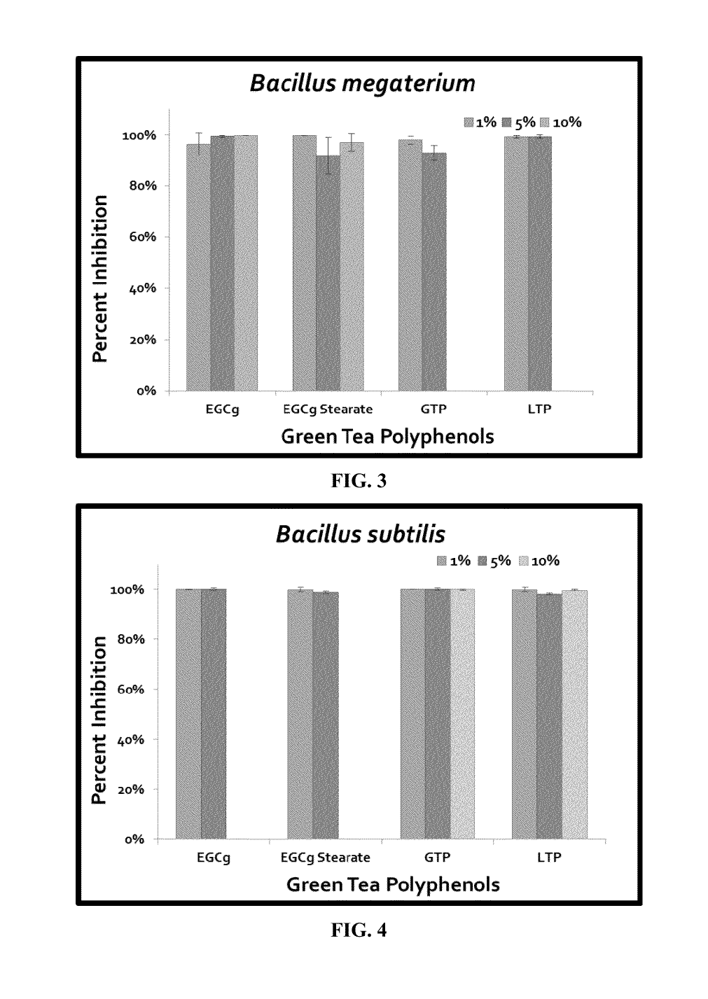

FIG. 3 is a bar graph of percent inhibition of Bacillus megaterium treated with 1%, 5%, of 10% of EGCG, EGCG Stearate, GTP or LTP.

TABLE 4
Average Percent Inhibition of B. megaterium

| Concentration | EGCg | EGCg-Stearate | GTP | LTP |
|---|---|---|---|---|
| 1% | 96.39% | 99.84% | 98.02% | 99.39% |
| 5% | 99.48% | 91.91% | 96.54% | 99.46% |
| 10% | 99.85% | 97.14% | — | — |

FIG. 4 is a bar graph of percent inhibition of Bacillus subtilis treated with 1%, 5%, of 10% of EGCG, EGCG Stearate, GTP or LTP.

TABLE 5
Average Percent Inhibition of B. subtilis

| Concentration | EGCg | EGCg-Stearate | GTP | LTP |
|---|---|---|---|---|
| 1% | 99.95% | 99.93% | 99.96% | 99.98% |
| 5% | 100% | 98.77% | 100% | 98.17% |
| 10% | — | — | 100% | 99.68% |

These data demonstrated promising inhibitory effects of endospore germination by green tea polyphenols. Average range of inhibition for hydrophilic treatment (GTP and EGCg) was 91.68%-100% while lipophilic treatments (LTP and EGCg-Stearate) were 88.81%-100%. Although purified tea polyphenols (EGCg and EGCg-S) show strong inhibitory results, crude extract forms of polyphenols (GTP and LTP) also show just as strong high inhibition. TEM images of spores with GTP treatment (data not shown) resulted in damage to spores' structural integrity, the spores with LTP treatment displayed complete surface disruption.

The data illustrates that these natural antimicrobial products could be useful in, for example, the food industry as a means of preventing food spoilage caused by spore forming bacteria, or in the medical industry to prevent contamination of devices.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. A method of reducing or preventing spore reactivation comprising contacting spores with an effective amount of one or more green tea polyphenols (GTP), one or more modified green tea polyphenols (LTP), or a combination thereof to prevent or reduce reactivation of the spores.

2. The method claim 1 wherein the spores are contacted with an effective amount of one or more modified green tea polyphenols to prevent or reduce reactivation of the spores.

3. The method of claim 1 wherein the one or more green tea polyphenols (GTP), one or more modified green tea polyphenols (LTP), or a combination thereof is (−)-epigallocatechin-3-gallate (EGCG).

4. The method of claim 1 wherein the one or more green tea polyphenols (GTP), one or more modified green tea polyphenols (LTP), or a combination thereof is (−)-epigallocatechin-3-gallate (EGCG) esterified at the 4′ position with stearic acid.

5. The method of claim 1 wherein the one or more green tea polyphenols (GTP), one or more modified green tea polyphenols (LTP), or a combination thereof is (−)-epigallocatechin-3-gallate (EGCG) esterified at the 4′ position with palmitic acid.

6. The method of claim 1 wherein the one or more green tea polyphenols, one or more modified green tea polyphenols, or a combination thereof are in an anti-spore composition further comprising one or more additional components selected from the group consisting of bioactive agents, therapeutic agents, excipients, carriers, fillers, additives, binders, disintegration agents, lubricants, flavoring agents, and combination thereof.

7. The method of claim 6 wherein the composition comprises less than 1%, 1%, 2%, 5%, 10%, 25%, or more than 25% of the one or more green tea polyphenols (GTP), one or more modified green tea polyphenols (LTP), or combination thereof.

8. The method of claim 1 further comprising contacting the spores with an antibiotic.

9. The method of claim 1 further comprising activating the spores.

10. The method of claim 9 wherein the spores are activated by heat, pH, or a reducing agent.

11. The method of claim 10 wherein the activation is a heat activation step comprising maintaining the temperature of the spores' environment to about 65° C. for at least 45 minutes.

12. The method of claim 10 wherein the activation is a heat activation comprising maintaining the temperature of the spores' environment to about 34° C. for at least 48 hours.

13. The method of claim 10 wherein the spores are activated by a pH activation step comprising maintaining the pH of the spores' environment at about 4.5.

14. The method of claim 10 wherein the spores are activated by contacting the spores with a reducing agent selected from the group consisting of mercaptoethanol and thioglycolate.

15. The method of claim 1 further comprising contacting the spores with one or more components of nutrient agar, sporulating agar, tryptic soy agar, LB agar, or a combination thereof.

16. The method of claim 15 wherein the spores are contacted with the one or more components of nutrient agar, sporulating agar, tryptic soy agar, LB agar, or a combination thereof prior to contacting the spores with the one or more green tea polyphenols, one or more modified green tea polyphenols, or combination thereof, or anti-spore composition thereof.

17. The method of claim 15 wherein the spores are contacted with the one or more components of nutrient agar, sporulating agar, tryptic soy agar, LB agar, or a combination thereof concurrently with contacting the spores with the one or more green tea polyphenols, one or more modified green tea polyphenols, or combination thereof, or anti-spore composition thereof.

18. The method of claim 17 wherein the one or more components of nutrient agar, sporulating agar, tryptic soy agar, LB agar, or a combination thereof are part of the anti-spore composition.

19. The method of claim 1 wherein the one or more green tea polyphenols, one or more modified green tea polyphenols, or combination thereof, or anti-spore composition thereof is contacted with the spores for minutes, hours, days, weeks, months, or years.

20. The method of any of claim 19 wherein the one or more green tea polyphenols, one or more modified green tea polyphenols, or combination thereof, or anti-spore composition thereof is contacted with the spores in an amount effective to reduce or prevent one or more hallmarks of germination or outgrowth selected from the group consisting of an increase in metabolic activity of the spore/bacterium, rupture or absorption of the spore coat, swelling of the spore, loss of resistance to environmental stress, the core of the spore manufacturing new chemical components, exiting the old spore coat, formation of a fully functional vegetative bacterial cell, and vegetative bacterial cell division.

21. A method of increasing the shelf-life of a food or a foodstuff comprising reducing or preventing reactivation of spores in or on the food or foodstuffs according to the method of claim 1.

22. A method of reducing spoilage of a food or a foodstuff comprising reducing or preventing reactivation of spores in or on the food or foodstuffs according to the method of claim 1.

23. A method decontaminating a device contaminated with spores comprising reducing or preventing reactivation of spores in or on the device according to the method of claim 1.

24. The method of claim 23 wherein the device is used for the collection, preparation, packaging or distribution of a food or a foodstuff.

25. The method of claim 23 wherein the device is a medical device or a surgical device.
